(19) United States
(12) Patent Application Publication
(10) Pub. No.: US 2024/0322178 A1
(43) Pub. Date: Sep. 26, 2024

(54) BINDER, AND ANODE AND LITHIUM BATTERY EACH INCLUDING SAME

(71) Applicant: SAMSUNG SDI CO., LTD., Yongin-si (KR)

(72) Inventors: Woojin Bae, Yongin-si (KR); Jongseok Moon, Yongin-si (KR); Kanghee Lee, Yongin-si (KR); Hyunsik Woo, Yongin-si (KR); Jongseok Park, Yongin-si (KR); Heemin Kim, Yongin-si (KR); Jinhwan Park, Yongin-si (KR)

(21) Appl. No.: 18/615,795

(22) Filed: Mar. 25, 2024

(30) Foreign Application Priority Data
Mar. 26, 2023 (KR) 10-2023-0039410
Apr. 18, 2023 (KR) 10-2023-0050726

(51) Int. Cl. H01M 4/62; H01M 4/02; H01M 4/66; H01M 10/052

(52) U.S. Cl. CPC H01M 4/622; H01M 4/661; H01M 4/667; H01M 2004/027; H01M 10/052

(57) ABSTRACT

A binder, and an anode and a lithium battery each including the binder are disclosed. The binder includes a third polymer being a cross-linked product of a first polymer and a water-soluble second polymer, where the first polymer includes a first functional group and at least one selected from polyamic acid and polyimide each substituted with fluorine, and the water-soluble second polymer includes a second functional group, wherein the first polymer is cross-linked to the second polymer by an ester bond formed via a reaction between the first functional group and the second functional group.

### CROSS-REFERENCE TO RELATED APPLICATION

The present application claims priority to and the benefit of Korean Patent Application Nos. 10-2023-0039410, filed on Mar. 26, 2023, and 10-2023-0050726 filed on Apr. 18, 2023, in the Korean Intellectual Property Office, the entire content of each of the two applications is incorporated herein by reference.

### BACKGROUND

### 1. Field

One or more embodiments of the present disclosure relate to a binder, and an anode and a lithium battery each including the same.

### 2. Description of the Related Art

In lithium batteries including a lithium metal-containing anode or lithium batteries including an anode initially not including an anode active material, protective layers are utilized to inhibit the formation of dendrites and have substantially uniform ion-flux when dendrites are formed.

As a protective layer, a polymer protective layer, an inorganic protective layer, or an organic/inorganic composite protective layer may be utilized, and a thickness of the protective layer should be 10 μm or more to obtain sufficient ionic (e.g., ion) conductivity. However, there have been issues in that, as the thickness of a protective layer increases, the current density of a lithium battery employing the protective layer also decreases.

Although a hybrid binder of polyimide and polyvinyl alcohol has been applied to a protective layer to solve these problems, a stable solid electrolyte interphase (SEI) was not easily formed during initial plating.

Therefore, in lithium batteries including a lithium metal-containing anode or lithium batteries including an anode initially not including an anode active material, a protective layer capable of providing high initial efficiency, excellent or suitable lifespan characteristics, having improved electrode stability, and enabling the suppression of changes in volume of an electrode, and a binder providing the protective layer are required and/or desired.

### SUMMARY

One or more aspects of embodiments of the present disclosure are directed toward a binder providing a protective layer providing improved initial capacity, lifespan characteristics, and electrode stability and inhibiting a volume change of an electrode.

One or more aspects of embodiments of the present disclosure are directed toward an anode including a protective layer including the binder.

One or more aspects of embodiments of the present disclosure are directed toward a lithium battery including the anode.

Additional aspects will be set forth in part in the description which follows and, in part, will be apparent from the description, or may be learned by practice of the presented embodiments of the present disclosure.

According to one or more embodiments of the present disclosure, a binder includes,

a third polymer as (e.g., being) a cross-linked product of a first polymer and a water-soluble second polymer, wherein the first polymer includes a first functional group and at least one selected from among polyamic acid and polyimide each substituted with fluorine, and the water-soluble second polymer includes a second functional group,

wherein the first polymer is cross-linked to the second polymer by an ester bond formed via a reaction between the first functional group and the second functional group.

According to one or more embodiments of the present disclosure,

an anode includes an anode current collector, and a protective layer on the anode current collector and including the binder.

According to one or more embodiments of the present disclosure,

a lithium battery includes a cathode, the anode, and an electrolyte between the cathode and the anode.

### BRIEF DESCRIPTION OF THE DRAWINGS

The accompanying drawing is included to provide a further understanding of the present disclosure, and is incorporated in and constitutes a part of this specification. The drawing illustrates example embodiments of the present disclosure and, together with the description, serve to explain principles of present disclosure. The above and other aspects, features, and advantages of certain embodiments of the present disclosure will be more apparent from the following description taken in conjunction with the accompanying drawings, in which:

FIG. 1 is a cross-sectional view of an anode according to one or more embodiments of the present disclosure;

FIG. 2 is a cross-sectional view of an anode according to one or more embodiments of the present disclosure;

FIG. 3 is a schematic diagram of a lithium battery according to one or more embodiments of the present disclosure;

FIG. 4 is a schematic diagram of a lithium battery according to one or more embodiments of the present disclosure; and

FIG. 5 is a schematic diagram of a lithium battery according to one or more embodiments of the present disclosure.

### DETAILED DESCRIPTION

Reference will now be made in more detail to embodiments, examples of which are illustrated in the accompanying drawings, wherein like reference numerals refer to like elements throughout the present disclosure, and duplicative descriptions thereof may not be provided for conciseness. In this regard, the presented embodiments may have different forms and should not be construed as being limited to the descriptions set forth herein. For example, the embodiments of the present disclosure are merely described, by referring to the drawings, to explain aspects of the present disclosure. As utilized herein, the term “and/or” or “or” may include any and all combinations of one or more of the associated listed items. Expressions such as “at least one of,” “one of,” and “selected from,” if preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation.

Hereinafter, a binder, and an anode and a lithium battery each including the binder will be described in more detail.

As utilized herein, the term “cross-link” refers to a bond connecting one polymer chain to another polymer chain. Throughout the present disclosure, the cross-link is a covalent bond. As utilized herein, the term “linker or cross-linker” refers to a functional group connecting one polymer chain to another polymer chain. As utilized herein, the term “cross-linked polymer” refers to a polymer in which one polymer chain is connected to another polymer chain via at least one linker. The cross-linked polymer may also be a product of a cross-linking reaction of one or more polymers.

As utilized herein, the term “substituted with fluorine” refers to a state in which a hydrogen included in a polymer is substituted with fluorine or a C1-C5 alkyl group substituted with fluorine.

A binder according to one or more embodiments may include a third polymer as (e.g., being) a cross-linked product of a first polymer and a water-soluble second polymer, wherein the first polymer includes a first functional group and at least one selected from among polyamic acid and polyimide each substituted with fluorine, and the water-soluble second polymer includes a second functional group, wherein the first polymer is cross-linked to the second polymer by an ester bond formed via a reaction between the first functional group and the second functional group. The third polymer may be a cross-linked polymer of the first polymer and the second polymer. A lithium battery including an anode including a protective layer including the binder may provide excellent or suitable anode stability derived from fluorine-containing polyimide, inhibit volume expansion of the anode, and provide both (e.g., simultaneously) increased initial charge/discharge efficiency and improved lifespan characteristics, because the binder includes the third polymer as (e.g., being) a cross-linked polymer of the fluorine-containing first polymer and the second polymer cross-linked via an ester bond.

In the binder, the first functional group and the second functional group respectively included in the first polymer and the second polymer may each independently be at least one selected from among a carboxyl group, a hydroxyl group, an amide group, and an aldehyde group, but embodiments of the present disclosure are not limited thereto, and any functional groups reacting with the first functional group and the second functional group to form a cross-link including an ester bond may also be utilized. For example, in one or more embodiments, the first functional group may be a carboxyl group (—COOH), and the second functional group may be a hydroxyl group (—OH). The carboxyl group may react with a hydroxyl group to form an ester bond. In the first polymer, the first functional group may not be linked to a trivalent aromatic group but linked to a side chain of a divalent aromatic group included in polyamic acid and/or polyimide.

In one or more embodiments, in the binder, the first polymer may include an alkali metal (e.g., an alkali metal ion). The alkali metal may be sodium, lithium, and/or the like. The first polymer may be substituted or doped with an alkali metal. For example, in some embodiments, in the polyamic acid, a hydrogen of a carboxyl group linked to the trivalent aromatic group included in the polyamic acid may be substituted with an alkali metal ion. For example, in some embodiments, in the polyimide, an alkali metal ion may be doped to form a coordinate bond with an amide group. As such, initial charge/discharge efficiency of a lithium battery may be increased because the first polymer previously includes an alkali metal (pre-lithiation).

A content (e.g., amount) of the alkali metal included in the first polymer may be about 0.2 to about 1.0, in an equivalence ratio (e.g., a molar ratio), to the carboxyl group or the amide group. For example, in some embodiments, the content (e.g., amount) of the alkali metal included in the first polymer may be about 0.2 to about 0.8 in an equivalence ratio (e.g., a molar ratio) to the carboxyl group or the amide group. For example, in some embodiments, the content (e.g., amount) of the alkali metal included in the first polymer may be about 0.3 to about 0.7 in an equivalence ratio (e.g., a molar ratio) to the carboxyl group or the amide group. For example, in some embodiments, the content (e.g., amount) of the alkali metal included in the first polymer may be about 0.4 to about 0.6 in an equivalence ratio (e.g., a molar ratio) to the carboxyl group or the amide group. For example, in some embodiments, the content (e.g., amount) of the alkali metal included in the first polymer may be about 0.45 to about 0.55 in an equivalence ratio (e.g., a molar ratio) to the carboxyl group or the amide group. Within the above-described ranges of the alkali metal content (e.g., amount), the binder may have more improved physical properties.

If (e.g., when) the Li content (e.g., amount) of polyamic acid, i.e., a degree of substitution of lithium ions, is less than 0.2 in an equivalence ratio (e.g., a molar ratio) to carboxylic acid, a pre-lithiation ratio may decrease, resulting in insignificant effect of inhibiting irreversibility in a first cycle. For example, if (e.g., when) the Li content (e.g., amount) of polyamic acid, i.e., a degree of substitution of lithium ions, is greater than 1.0 in an equivalence ratio (e.g., a molar ratio) to carboxylic acid, an imidation ratio may significantly decrease, resulting in deterioration of lifespan characteristics. The Li content (e.g., amount) range, i.e., degree of substitution of lithium ions, may be obtained by adding LiOH utilized for lithiation of polyamic acid in an equivalence ratio (e.g., a molar ratio) of about 0.2 to about 1.0 to carboxylic acid of polyamic acid.

For example, in one or more embodiments, the polyimide may be represented by Formula 1 or Formula 2.

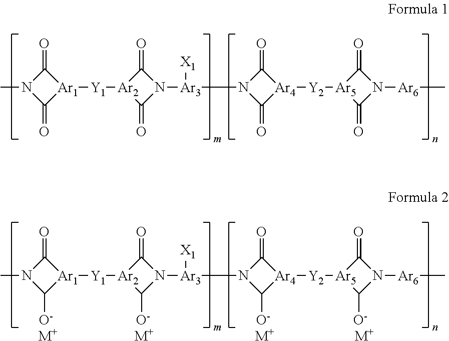

In Formulae 1 and 2,

M may be an alkali metal,

Ar₁, Ar₂, Ar₄, and Ar₅ may each independently be an aromatic cyclic group selected from among: a trivalent C6-C24 arylene group unsubstituted or substituted with a halogen and/or a C1-C10 alkyl group unsubstituted or substituted with a halogen; and a trivalent C4-C24 heteroarylene group unsubstituted or substituted with a halogen and/or a C1-C10 alkyl group unsubstituted or substituted with a halogen, wherein the aromatic cyclic group may be a single aromatic ring, a fused ring of two or more aromatic rings, or a linked ring moiety of two or more aromatic rings linked via a single bond, —O—, —S—, —C(═O)—, —S(═O)₂—, —Si(Ra)(Rb)- (wherein Ra and Rb may each independently be a C1-C10 alkyl group), a C1-C10 alkylene group unsubstituted or substituted with a halogen, or —C(═O)—NH—O, and

Ar₃ and Ar₆ may each independently be an aromatic cyclic group selected from among: a divalent C6-C24 arylene group unsubstituted or substituted with fluorine or a C1-C10 alkyl group unsubstituted or substituted with fluorine; and a divalent C4-C24 heteroarylene group unsubstituted or substituted with fluorine or a C1-C10 alkyl group unsubstituted or substituted with fluorine, wherein the aromatic cyclic group may be a single aromatic ring, a fused ring of two or more aromatic rings, or a linked ring moiety of two or more aromatic rings linked via a single bond, —O—, —S—, —C(═O)—, —S(═O)₂—, —Si(Ra)(Rb)- (wherein Ra and Rb may each independently be a C1-C10 alkyl group), a C1-C10 alkylene group unsubstituted or substituted with a halogen, or —C(═O)—NH—, X₁ may be —COOH, —OH, —CO—NH₂, or —COH, Y₁ and Y₂ may each independently be a single bond or a C1-C10 alkylene group substituted with fluorine, and each of n and m may be a mole fraction in a repeating unit satisfying 0<n<1, 0<m<1, and n+m=1.

For example, in one or more embodiments, the polyimide may be represented by Formula 3 or Formula 4.

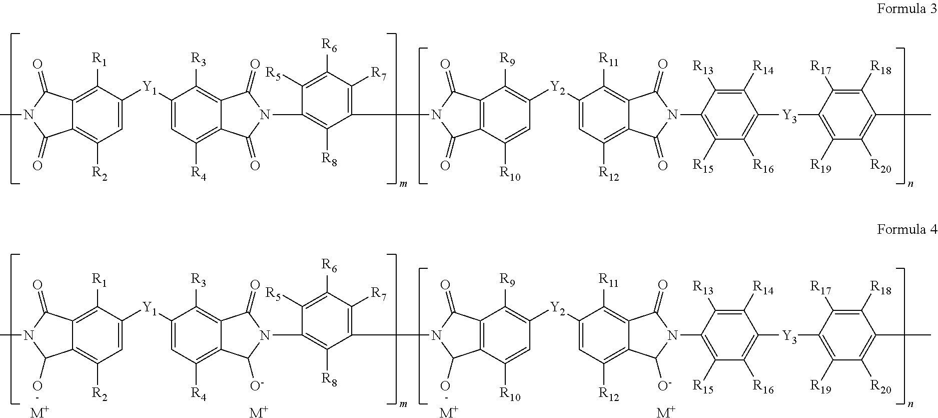

In Formulae 3 and 4,

M may be lithium or sodium,

R₁ to R₂₀ may each independently be: hydrogen, a halogen; —COOH; —OH; —CO—NH₂; —COH; a C1-C10 alkyl group unsubstituted or substituted with a halogen; a C6-C20 aryl group unsubstituted or substituted with a halogen; or a C2-C20 heteroaryl group unsubstituted or substituted with a halogen, wherein at least one selected from among R₅ to R₈ may be —COOH, —OH, —CO—NH₂, or —COH, at least one selected from among R₁₃ to R₂₀ may be a C1-C10 alkyl group substituted with fluorine, Y₁ to Y₃ may each independently be a single bond or a C1-C10 alkylene group substituted with fluorine, and each of n and m may be a mole fraction in a repeating unit satisfying 0<n<1, 0<m<1, and n+m=1.

For example, in one or more embodiments, the polyamic acid may be represented by Formula 7 or Formula 8.

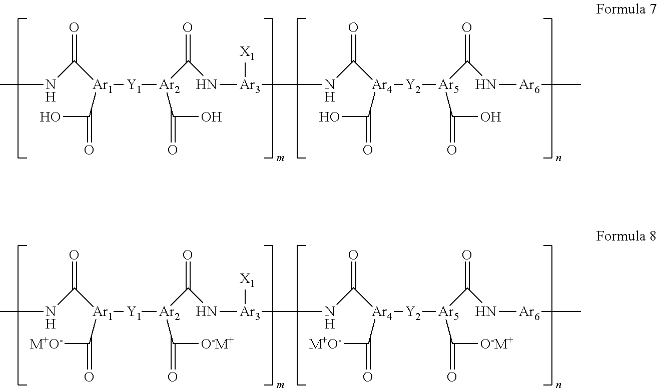

In Formulae 7 and 8,

M may be an alkali metal,

Ar₁, Ar₂, Ar₄ and Ar₅ may each independently be an aromatic cyclic group selected from among: a trivalent C6-C24 arylene group unsubstituted or substituted with a halogen or a C1-C10 alkyl group unsubstituted or substituted with a halogen; and a trivalent C4-C24 heteroarylene group unsubstituted or substituted with a halogen or a C1-C10 alkyl group unsubstituted or substituted with a halogen, wherein the aromatic cyclic group may be a single aromatic ring, a fused ring of two or more aromatic rings, or a linked ring moiety of two or more aromatic rings linked via a single bond, —O—, —S—, —C(═O)—, —S(═O)₂—, —Si(Ra)(Rb)- (wherein Ra and Rb may each independently be a C1-C10 alkyl group), a C1-C10 alkylene group unsubstituted or substituted with a halogen, or —C(═O)—NH—O,

Ar₃ and Ar₆ may each independently be an aromatic cyclic group selected from among: a divalent C6-C24 arylene group unsubstituted or substituted with fluorine or a C1-C10 alkyl group unsubstituted or substituted with fluorine; and a divalent C4-C24 heteroarylene group unsubstituted or substituted with fluorine or a C1-C10 alkyl group unsubstituted or substituted with fluorine, wherein the aromatic cyclic group may be a single aromatic ring, a fused ring of two or more aromatic rings, or a linked ring moiety of two or more aromatic rings linked via a single bond, —O—, —S—, —C(═O)—, —S(═O)₂—, —Si(Ra)(Rb)- (wherein Ra and Rb may each independently be a C1-C10 alkyl group), a C1-C10 alkylene group unsubstituted or substituted with a halogen, or —C(═O)—NH—,

X₁ may be —COOH, —OH, —CO—NH₂, or —COH, Y₁ and Y₂ may each independently be a single bond or a C1-C10 alkylene group substituted with fluorine, and each of n and m may be a mole fraction in a repeating unit satisfying 0<n<1, 0<m<1, and n+m=1.

For example, in one or more embodiments, the polyamic acid may be represented by Formula 9 or Formula 10.

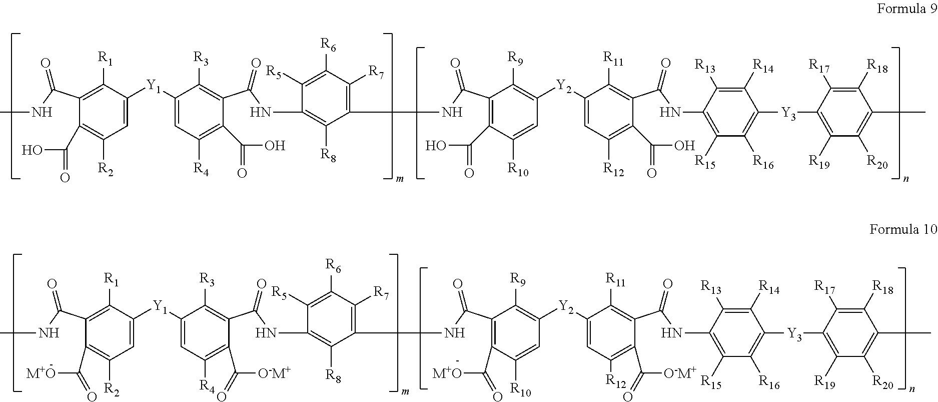

In Formulae 9 and 10,

M may be lithium or sodium,

R₁ to R₂₀ may each independently be: hydrogen; a halogen; —COOH; —OH; —CO—NH₂; —COH; a C1-C10 alkyl group unsubstituted or substituted with a halogen; a C6-C20 aryl group unsubstituted or substituted with a halogen; or a C2-C20 heteroaryl group unsubstituted or substituted with a halogen, wherein at least one selected from among R₅ to R₈ may be —COOH, —OH, —CO—NH₂, or —COH, at least one selected from among R₁₃ to R₂₀ may be a C1-C10 alkyl group substituted with fluorine, Y₁ to Y₃ may each independently be a single bond or a C1-C10 alkylene group substituted with fluorine, and each of n and m may be a mole fraction in a repeating unit satisfying 0<n<1, 0<m<1, and n+m=1.

For example, in one or more embodiments, in the binder, the polyimide may be represented by Formula 5 or Formula 6, and the polyamic acid may be represented by Formula 11 or Formula 12.

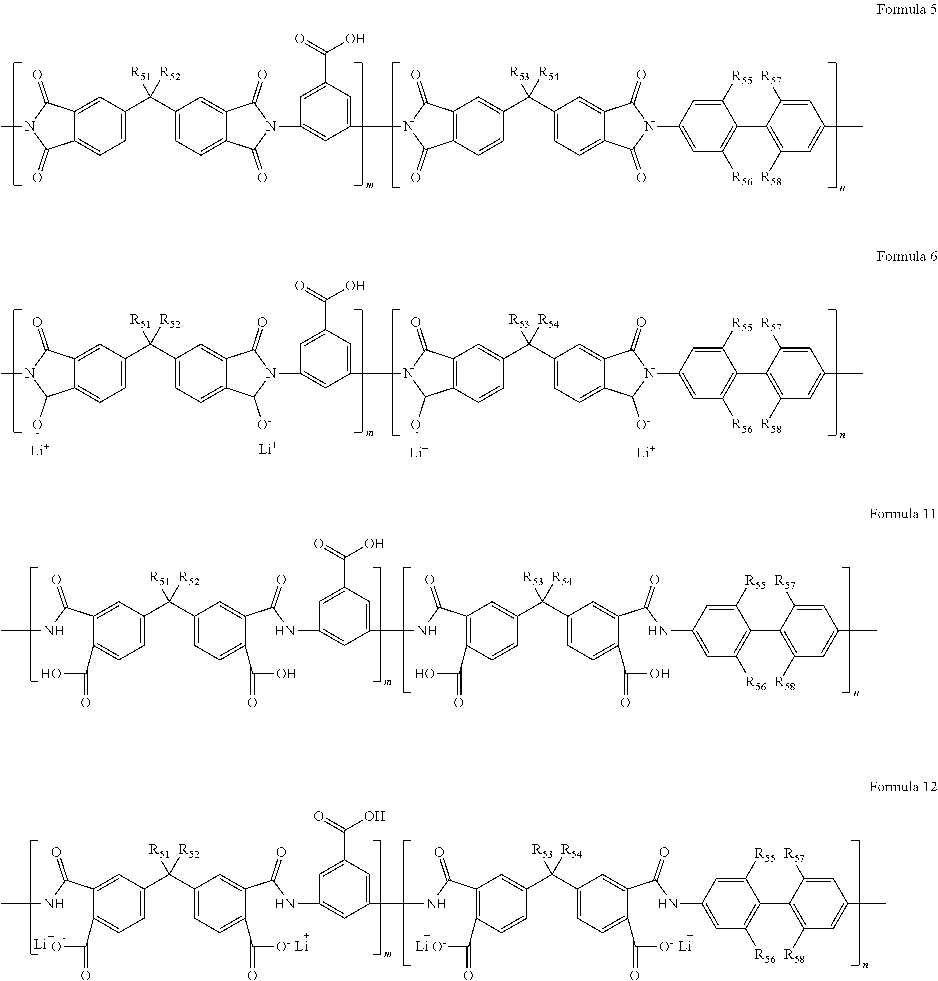

In Formulae 5, 6, 11, and 12,

R₅₁ to R₅₈ may each independently be hydrogen or a C1-C10 alkyl group unsubstituted or substituted with fluorine (F), wherein at least one selected from among R₅₁ to R₅₈ may be a C1-C10 alkyl group substituted with fluorine, and each of n and m may be a mole fraction in a repeating unit satisfying 0<n<1, 0<m<1, and n+m=1.

For example, in one or more embodiments, in the first polymer represented by any one selected from among Formulae 1 to 12, a mole fraction in a repeating unit including a cross-linker to a repeating unit not including a cross-linker may satisfy 0<m<0.5, 0.5<n<1, and m+n=1. For example, in one or more embodiments, in the first polymer represented by any one selected from among Formulae 1 to 12, the mole fraction of a repeating unit including a cross-linker to a repeating unit not including a cross-linker may satisfy 0.1<m<0.4, 0.6<n<0.9, and m+n=1. For example, in one or more embodiments, in the first polymer represented by any one selected from among Formulae 1 to 12, the mole fraction of a repeating unit including a cross-linker to a repeating unit not including a cross-linker may satisfy 0.15<m<0.35, 0.65<n<0.85, and m+n=1. For example, in one or more embodiments, in the first polymer represented by any one selected from among Formulae 1 to 12, the mole fraction of a repeating unit including a cross-linker to a repeating unit not including a cross-linker may be 0.2<m<0.3, 0.7<n<0.8, and m+n=1. Within the above-described mole fraction ranges, the binder may provide more improved physical properties.

For example, in some embodiments, the first polymer represented by any one selected from among Formulae 1 to 12 may be a random copolymer. For example, in some embodiments, the first polymer represented by any one selected from among Formulae 1 to 12 may be a block copolymer.

In one or more embodiments, the first polymer may have a weight average molecular weight of about 10,000 Da to about 1,200,000 Da. For example, in some embodiments, in the binder, the first polymer may have a weight average molecular weight of about 10,000 Da to about 1,100,000 Da. For example, in some embodiments, in the binder, the first polymer may have a weight average molecular weight of about 10,000 Da to about 1,000,000 Da. For example, in some embodiments, the first polymer may have a weight average molecular weight of about 10,000 Da to about 500,000 Da. For example, in some embodiments, the first polymer may have a weight average molecular weight of about 100,000 Da to about 500,000 Da. For example, in some embodiments, the first polymer may have a weight average molecular weight of about 100,000 Da to about 400,000 Da. For example, in some embodiments, the first polymer may have a weight average molecular weight of about 100,000 Da to about 300,000 Da. Within the above-described ranges of the weight average molecular weight of the first polymer, physical properties of the binder may further be improved. The weight average molecular weight is measured using Gel Permeation Chromatography (GPC).

In the binder, the second polymer may be a polymerization product of at least one monomer selected from among vinyl monomers, acetate monomers, alcohol monomers, acrylic monomers, methacrylic monomers, acrylamide monomers, and methacrylamide monomers, and/or a hydrolysate thereof.

For example, in one or more embodiments, the second polymer may be a polymerization product of at least one monomer selected from among vinyl acetate, vinyl alcohol, butyl (meth)acrylate, 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 2-hydroxyethyleneglycol (meth)acrylate, 2-hydroxypropyleneglycol (meth)acrylate, acrylic acid, methacrylic acid, 2-(meth)acryloyloxy acetic acid, 3-(meth)acryloyloxy propyl acid, 4-(meth)acryloyloxy butyl acid, itaconic acid, maleic acid, 2-isocyanatoethyl (meth)acrylate, 3-isocyanatopropyl (meth)acrylate, 4-isocyanatobutyl (meth)acrylate, (meth)acrylamide, ethylenedi(meth)acrylate, diethyleneglycol(meth)acrylate, triethyleneglycoldi(meth)acrylate, trimethylenepropanetri(meth)acrylate, trimethylenepropanetriacrylate, 1,3-butanediol(meth)acrylate, 1,6-hexanedioldi(meth)acrylate, allyl acrylate, and N-vinyl caprolactam, and/or a hydrolysate thereof.

For example, in one or more embodiments, the second polymer may be polyvinylalcohol (PVA). For example, polyvinylalcohol may be a hydrolysate obtained by alkaline hydrolyzing polyvinyl acetate.

The polyvinylalcohol may have a saponification degree of about 60% to about 99%. For example, in some embodiments, the polyvinylalcohol may have a saponification degree of about 70% to about 95%. For example, in some embodiments, the polyvinylalcohol may have a saponification degree of about 75% to about 90%. For example, in some embodiments, the polyvinylalcohol may have a saponification degree of about 80% to about 90%. For example, in some embodiments, the polyvinylalcohol may have a saponification degree of about 85% to about 90%. Within the above-described ranges of the saponification degree, the binder may provide further improved physical properties.

The polyvinylalcohol may have a weight average molecular weight of about 10,000 Da to about 500,000 Da. For example, in some embodiments, the polyvinylalcohol may have a weight average molecular weight of about 10,000 Da to about 500,000 Da. For example, in some embodiments, the polyvinylalcohol may have a weight average molecular weight of about 10,000 Da to about 400,000 Da. For example, in some embodiments, the polyvinylalcohol may have a weight average molecular weight of about 10,000 Da to about 300,000 Da. For example, in some embodiments, the polyvinylalcohol may have a weight average molecular weight of about 10,000 Da to about 200,000 Da. For example, in some embodiments, the polyvinylalcohol may have a weight average molecular weight of about 50,000 Da to about 150,000 Da. For example, in some embodiments, the polyvinylalcohol may have a weight average molecular weight of about 70,000 Da to about 100,000 Da. For example, in some embodiments, the polyvinylalcohol may have a weight average molecular weight of about 80,000 Da to about 100,000 Da. Within the above-described ranges of the weight average molecular weight of the polyvinylalcohol, physical properties of the binder may further be improved.

In one or more embodiments, in the binder, a weight ratio of the first polymer to the second polymer which are included in the third polymer may be about 1:99 to about 50:50. For example, in some embodiments, in the binder, the weight ratio of the first polymer to the second polymer which are included in the third polymer may be from about 5:95 to about 45:55. For example, in some embodiments, in the binder, the weight ratio of the first polymer to the second polymer which are included in the third polymer may be from about 5:95 to about 40:60. For example, in some embodiments, in the binder, the weight ratio of the first polymer to the second polymer which are included in the third polymer may be from about 5:95 to about 35:65. For example, in some embodiments, in the binder, the weight ratio of the first polymer to the second polymer which are included in the third polymer may be from about 10:90 to about 30:70. Within the above-described weight ratio ranges of the first polymer to the second polymer, physical properties of the binder may further be improved.

In one or more embodiments, in the binder, the cross-linking reaction may be performed at a temperature of 100° C. or above. For example, in some embodiments, the cross-linking reaction may be performed by heat-treating a composition including the first polymer and the second polymer at a temperature of 100° C. or above. For example, in some embodiments, the cross-linking reaction may be performed by heat-treating a composition including the first polymer and the second polymer at a temperature of 120° C. or above. For example, in some embodiments, the cross-linking reaction may be performed by heat-treating a composition including the first polymer and the second polymer at a temperature of 140° C. or above. For example, in some embodiments, the cross-linking reaction may be performed by heat-treating a composition including the first polymer and the second polymer at a temperature of 160° C. or above. Within the above-described temperature ranges, the cross-linking reaction may proceed to produce a cross-linked polymer.

For example, in one or more embodiments, in the binder, polyamic acid may be cured into polyimide while the cross-linking reaction is performed at a temperature of 100° C. or above. For example, in some embodiments, the polyamic acid may have an imidation rate of 60% or more. For example, in some embodiments, the polyamic acid may have an imidation rate of 70% or more. For example, in some embodiments, the polyamic acid may have an imidation rate of 80% or more. For example, in some embodiments, the polyamic acid may have an imidation rate of 90% or more. The imidation rate of the polyamic acid may be obtained by utilizing ¹H-NMR. Mechanical properties of the binder may further be improved because polyamic acid is cured into polyimide in the binder.

According to one or more embodiments, the polyamic acid may have an acid equivalent of less than 300 g/eq. For example, in some embodiments, the polyamic acid may have an acid equivalent of about 50 g/eq to about 250 g/eq. By lowering the acid equivalent of polyamic acid to less than 300 g/eq, the amount of carboxyl groups and/or carboxylates per unit mass may increase. If (e.g., when) a silicon-based anode active material is utilized as a material for an anode, the increased amount of carboxyl groups and/or carboxylates per unit mass may increase interaction between the binder and an anode active material including a hydroxyl group on the surface thereof, thereby increasing binding strength with the anode active material. If (e.g., when) the acid equivalent is 300 g/eq or more, initial efficiency and lifespan characteristics of the lithium battery may deteriorate.

In the binder, a modulus of the third polymer may have a value greater than each of a modulus of the first polymer and a modulus of the second polymer. As a cross-linked polymer formed by cross-linking the first polymer to the second polymer, the third polymer may have increased stiffness due to the increased modulus. For example, in some embodiments, the third polymer may have a modulus of 5 GPa or more. For example, in some embodiments, the third polymer may have a modulus of 6 GPa or more. For example, in some embodiments, the third polymer may have a modulus of 7 GPa or more The modulus may be an indentation modulus.

In the binder, an indentation hardness of the third polymer may be greater than each of an indentation hardness of the first polymer and an indentation hardness of the second polymer. For example, as a cross-linked polymer formed by cross-linking the first polymer to the second polymer, the third polymer may have an increased surface indentation hardness.

In the binder, the third polymer, as a cross-linked polymer, may have a three-dimensional network structure in which a plurality of first polymer chains are cross-linked to a plurality of second polymer chains via linkers or cross-linkers. A volume change of an electrode including the binder may be inhibited during charging and discharging because the third polymer has the network structure.

In one or more embodiments, in the binder, the third polymer may have a weight average molecular weight of about 10,000 Da to about 1,500,000 Da. For example, in some embodiments, in the binder, the third polymer may have a weight average molecular weight of about 10,000 Da to about 1,200,000 Da. For example, in some embodiments, in the binder, the third polymer may have a weight average molecular weight of about 10,000 Da to about 1,100,000 Da. For example, in some embodiments, in the binder, the third polymer may have a weight average molecular weight of about 10,000 Da to about 1000,000 Da. For example, in some embodiments, the third polymer may have a weight average molecular weight of about 10,000 Da to about 500,000 Da. For example, in some embodiments, the third polymer may have a weight average molecular weight of about 100,000 Da to about 500,000 Da. For example, in some embodiments, the third polymer may have a weight average molecular weight of about 100,000 Da to about 400,000 Da. For example, in some embodiments, the third polymer may have a weight average molecular weight of about 100,000 Da to about 300,000 Da. Within the above-described ranges of the weight average molecular weight of the third polymer, physical properties of the binder may further be improved.

For example, in one or more embodiments, in the binder, the third polymer may be represented by one or more compounds represented by Formulae 13 to 16.

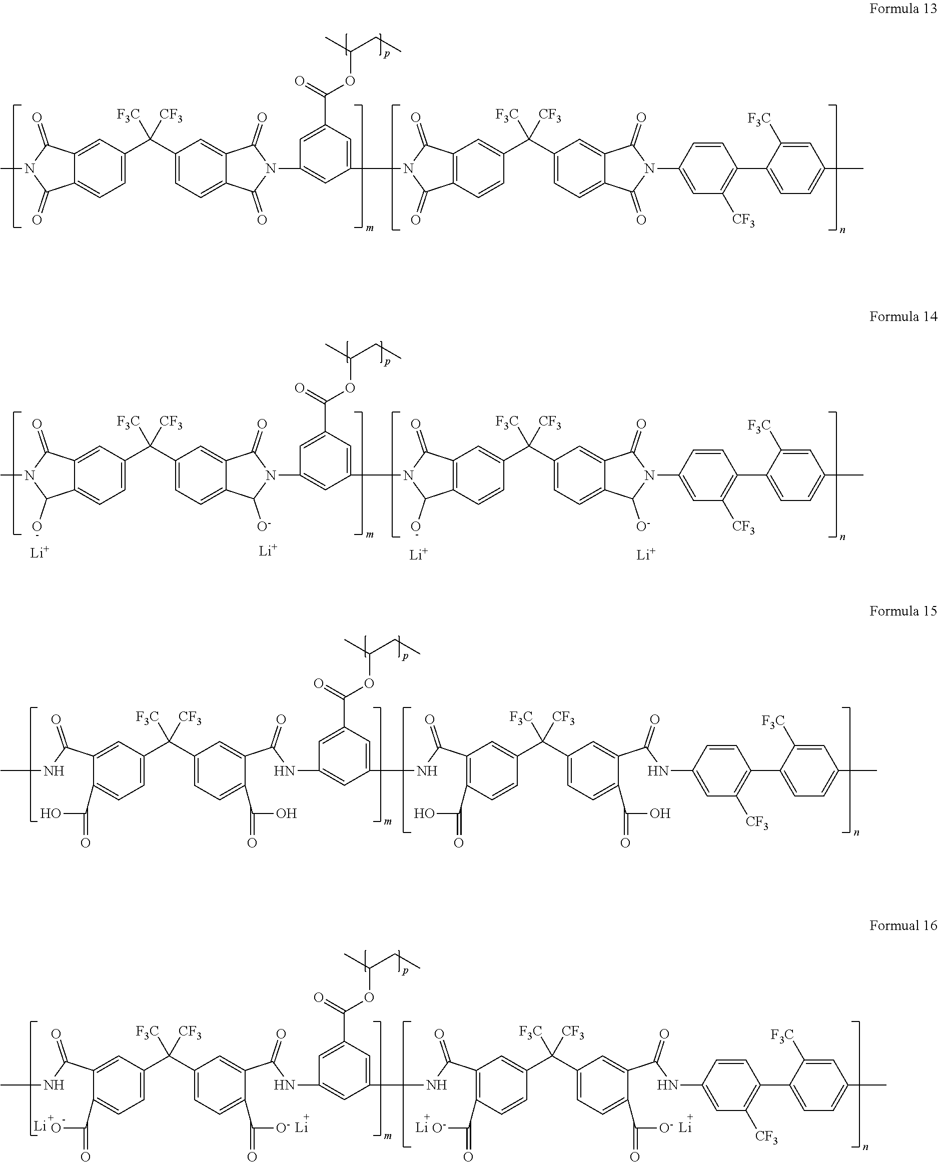

In the formulae 13 to 16, each of n and m may be a mole fraction in the repeating units satisfying 0<n<1, 0<m<1, and n+m=1, and p, as a degree of polymerization, may be about 250 to about 12500.

In one or more embodiments, the binder may further include a water-soluble fourth polymer selected from among cellulose, hydroxyethyl ether, dextran, carboxymethylcellulose (CMC), alginate, cellulose nanofiber, xanthan gum, and guar gum. If (e.g., when) the binder includes the fourth polymer, physical properties of the binder may be adjusted in one or more suitable manners.

The binder may be utilized, for example, in an electrochemical cell. The binder may be utilized, for example, in a protective layer included in an electrochemical cell. Types of the electrochemical cell are not limited as long as the electrochemical cell stores energy via electrochemical reaction and may include primary and secondary batteries. Non-limiting examples of the electrochemical cell may include (e.g., may be) alkali metal batteries such as lithium batteries and/or sodium batteries, alkaline earth metal batteries such as magnesium batteries, metal-air batteries, super capacitors, and fuel cells.

An anode according to one or more embodiments may include: an anode current collector; and a protective layer on the anode current collector and including the above-described binder.

Hereinafter, an anode including a protective layer including the binder and a lithium battery including the anode according to one or more embodiments will be described in more detail.

### Anode

An anode for a lithium battery according to one or more embodiments may include: an anode current collector; and a protective layer on one side of the anode current collector, wherein the protective layer may include the binder of the present disclosure. A lithium battery including the anode may have improved initial efficiency, lifespan characteristics, and electrode stability because the anode includes the protective layer including the binder. In one or more embodiments, a volume change of the lithium battery may be inhibited.

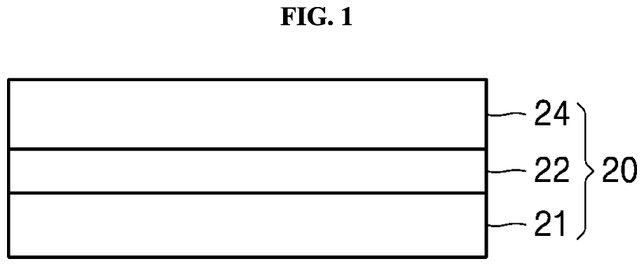

Referring to FIG. 1, in one or more embodiments, an anode 20 may include: an anode current collector 21; and a protective layer 24 on the anode current collector 21, wherein the protective layer 24 includes the binder.

According to one or more embodiments, the anode 20 may further include an anode interlayer 22 between the anode current collector 21 and the protective layer 24.

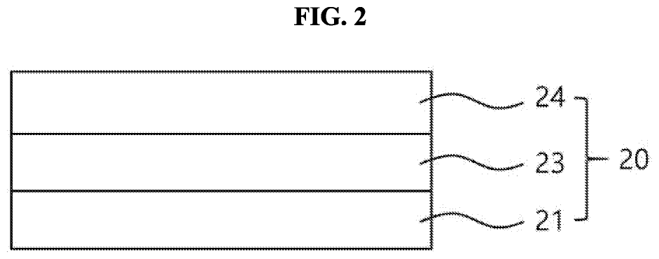

Referring to FIG. 2, in one or more embodiments, the anode 20 may further include an anode active material layer 23 between the protective layer 24 and the anode current collector 21.

### Anode: Protective Layer

Referring to FIG. 1 and FIG. 2, in one or more embodiments, the anode 20 may include: an anode current collector 21; and a protective layer 24 on the anode current collector 21. The protective layer 24 may include the binder of the present disclosure.

According to one or more embodiments, the protective layer 24 may have a thickness of 5 μm or less. In one or more embodiments, the protective layer 24 may have a thickness of, for example, about 0.1 μm to about 5 μm, about 0.1 μm to about 3 μm, about 0.1 μm to about 2 μm, about 0.1 μm to about 1.5 μm, about 0.1 μm to about 1.2 μm, about 0.1 μm to about 1.2 μm, or about 0.2 μm to about 1 μm. Within the above-described ranges of the thickness of the protective layer 24, the protective layer may effectively inhibit decomposition of an electrolyte to suppress or reduce local imbalance of current density, thereby effectively inhibiting formation and/or growth of lithium dendrite. Therefore, a lithium battery including the protective layer 24 may have further improved cycle characteristics. If (e.g., when) the protective layer 24 is too thick, energy density of the lithium battery may decrease. If (e.g., when) the protective layer 24 is too thin, cycle characteristics of the lithium battery may be insignificantly improved.

According to one or more embodiments, the protective layer 24 may have a modulus of 5 GPa or more. For example, in some embodiments, the third polymer may have a modulus of 6 GPa or more. For example, in some embodiments, the third polymer may have a modulus of 7 GPa or more. The modulus may be an indentation modulus.

According to one or more embodiments, the protective layer 24 may have a recovery of 50% or more. For example, in some embodiments, the protective layer 24 may have a recovery of 55% or more. For example, in some embodiments, the protective layer 24 may have a recovery of 60% or more. For example, in some embodiments, the protective layer 24 may have a recovery of 65% or more.

According to one or more embodiments, the protective layer 24 may have an indentation hardness of 1200 N/mm² or more. For example, in some embodiments, the protective layer 24 may have an indentation hardness of 1300 N/mm² or more. For example, in some embodiments, the protective layer 24 may have an indentation hardness of 1400 N/mm² or more. For example, in some embodiments, the protective layer 24 may have an indentation hardness of 1450 N/mm² or more. For example, in some embodiments, the protective layer 24 may have an indentation hardness of 1500 N/mm² or more. For example, in some embodiments, the protective layer 24 may have an indentation hardness of 1550 N/mm² or more.

According to one or more embodiments, the protective layer 24 may be prepared by curing a protective layer-forming composition which will be described later. The protective layer-forming composition may include the first polymer and the second polymer. The protective layer 24 may be formed, for example, by applying the protective layer-forming composition onto the anode current collector 21 and curing the protective layer-forming composition at a temperature of 100° C. or above.

In one or more embodiments, the protective layer 24 may be formed, for example, by applying the protective layer-forming composition onto the anode current collector 21 and heat-treating the protective layer-forming composition at a temperature of 100° C. or above for about 1 hour to about 10 hours. In one or more embodiments, the protective layer 24 may be formed, for example, by applying the protective layer-forming composition onto the anode current collector 21 and heat-treating the protective layer-forming composition at a temperature of 160° C. or above for about 1 hour to about 10 hours.

According to one or more embodiments, the protective layer 24 may further include a conductive material.

The conductive material may be one or more selected from among carbon black, graphite particulates, natural graphite, artificial graphite, acetylene black, Ketjen black, carbon fiber; carbon nanotubes; metal such as copper, nickel, aluminum, and silver each of which is utilized in powder, fiber, or tube form; and/or conductive polymers such as polyphenylene derivatives, but embodiments of the present disclosure are not limited to, and any materials commonly utilized in the art as conductive materials may also be utilized.

### Anode: Anode Current Collector

Referring to FIG. 1 and FIG. 2, the anode 20 may include an current collector 21.

The anode current collector 21 may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or one or more alloys thereof.

In one or more embodiments, the anode current collector 21 may include, for example, a first metal substrate. The first metal substrate may include a first metal as a main component or may only include (e.g., consist of) the first metal. A content (e.g., amount) of the first metal contained in the first metal substrate may be, for example, 90 wt % or more, 95 wt % or more, 99 wt % or more, or 99.9 wt % or more based on a total weight of the first metal substrate. The first metal substrate may be formed of, for example, a material that does not react with lithium, i.e., a material that does not form an alloy and/or compound with lithium. The first metal may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or any alloy thereof. In one or more embodiments, the first metal substrate may be formed of, for example, one metal selected from those described above or an alloy of two or more metals selected therefrom. The first metal substrate may be, for example, in the form of a sheet or foil. A thickness of the anode current collector 21 may be, for example, from 5 μm to 50 μm, from 10 μm to 50 μm, from 10 μm to 40 μm, or from 10 μm to 30 μm, but is not limited thereto and may be selected according to required properties of the lithium battery.

For example, in one or more embodiments, the anode current collector 21 may include the first metal substrate and a coating layer on the first metal substrate and including a second metal. The second metal may have a higher Mohs hardness than that of the first metal. For example, because the coating layer including the second metal is harder than the first metal substrate including the first metal, deterioration of the first metal substrate may be prevented or reduced. For example, in one or more embodiments, a material constituting the first metal substrate may have a Mohs hardness of 5.5 or less. In one or more embodiments, the Mohs hardness of the first metal may be, for example, 5.5 or less, 5.0 or less, 4.5 or less, 4.0 or less, 3.5 or less, or 3.0 or less. In some embodiments, the Mohs hardness of the first metal may be, for example, from about 2.0 to about 6.0. The coating layer may include the second metal. For example, the coating layer may include the second metal as a main component or include (e.g., consist of) the second metal. In one or more embodiments, a content (e.g., amount) of the second metal contained in the coating layer may be, for example, 90 wt % or more, 95 wt % or more, 99 wt % or more, or 99.9 wt % or more based on a total weigh of the coating layer. The coating layer may be formed of, for example, a material that does not react with lithium, i.e., a material that does not form an alloy and/or compound with lithium. The Mohs hardness of the material constituting the coating layer may be, for example, 6.0 or more. For example, the Mohs hardness of the second metal may be 6.0 or more, 6.5 or more, 7.0 or more, 7.5 or more, 8.0 or more, 8.5 or more, or 9.0 or more. In some embodiments, the Mohs hardness of the second metal may be, for example, from about 6.0 to about 12. If (e.g., when) the Mohs hardness of the second metal is too low, deterioration of the anode current collector may not be inhibited. If (e.g., when) the Mohs hardness of the second metal is too high, processing may not be easy. For example, in one or more embodiments, the second metal may include at least one selected from among titanium (Ti), manganese (Mn), niobium (Nb), tantalum (Ta), iridium (Ir), vanadium (V), rhenium (Re), osmium (Os), tungsten (W), chromium (Cr), boron (B), ruthenium (Ru), and rhodium (Rh). The coating layer may be formed of, for example, one of the metals described above or an alloy of at least two metals selected therefrom. In one or more embodiments, a Mohs hardness difference between the first metal included in the first metal substrate and the second metal included in the coating layer may be, for example, 2 or more, 2.5 or more, 3 or more, 3.5 or more, or 4 or more. If (e.g., when) the Mohs hardness difference between the first metal and the second metal is within the ranges described above, deterioration of the anode current collector may be more effectively inhibited. The coating layer may have a single-layer structure or a multilayer structure including two or more layers. For example, in some embodiments, the coating layer may have a double-layer structure including a first coating layer and a second coating layer. For example, in some embodiments, the coating layer may have a triple-layer structure including a first coating layer, a second coating layer, and a third coating layer. In one or more embodiments, a thickness of the coating layer may be, for example, from 10 nm to 1 μm, from 50 nm to 500 nm, from 50 nm to 200 nm, or from 50 nm to 150 nm. If (e.g., when) the coating layer is too thin, it may be difficult to inhibit non-substantially uniform growth of the lithium-containing metal layer. As the thickness of the coating layer increases, cycle characteristics of the lithium battery may be improved. However, if (e.g., when) the coating layer is too thick, energy density of the lithium battery may decrease and formation of the coating layer may not be easy. The coating layer may be disposed on the first metal substrate by, for example, vacuum deposition, sputtering, or plating, but embodiments of the present disclosure are not limited thereto, and any method of providing the coating layer commonly utilized in the art may also be utilized.

In one or more embodiments, the anode current collector 21 may include, for example, a base film and a metal layer disposed on one or both (e.g., simultaneously on two opposite) sides of the base film. The base film may include, for example, a polymer. The polymer may include, for example, polyethyleneterephthalate (PET), polyethylene (PE), polypropylene (PP), polybutyleneterephthalate (PBT), polyimide (PI), or any combination thereof. The metal layer may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or any alloy thereof. If (e.g., when) the anode current collector has the above-described structure, the weight of an anode may be reduced, so that energy density of the lithium battery may be increased.

### Anode: Anode Interlayer

Referring to FIG. 1, in one or more embodiments, the anode 20 may include an anode interlayer 22 between the anode current collector 21 and the protective layer 24. Formation and/or growth of lithium dendrite may be more effectively inhibited because the anode 20 includes the anode interlayer 22.

In some embodiments, the anode interlayer 22 may include, for example, a lithiophilic metal. In some embodiments, the anode interlayer 22 may include, for example, a lithiophilic metal and a carbonaceous material.

The lithiophilic metal may be a material allowing lithiation and delithiation. The anode interlayer 22 may be formed by introducing the lithiophilic metal onto the anode current collector 21 via nanoparticle casting. If (e.g., when) the anode interlayer 22 is introduced onto the anode current collector 21 by nanoparticle casting, lithium ions may pass through the anode interlayer 22 to form lithium metal between the anode interlayer 22 and the anode current collector 21.

In one or more embodiments, the lithiophilic metal included in the anode interlayer 22 may be nanoparticles of the lithiophilic metal. The lithiophilic metal in the form of particles may have an average particle diameter of, for example, about 10 nm to about 4 μm, about 10 nm to about 1 μm, about 10 nm to about 500 nm, about 10 nm to about 100 nm, or about 20 nm to about 80 nm. Reversible plating and/or dissolution of lithium may occur more easily during a charge/discharge process because the lithiophilic metal has an average particle diameter within the ranges described above. For example, due to the nano-sized particle diameter of the lithiophilic metal, lithium ions may transmit the anode interlayer 22 including the lithiophilic metal, and thus lithium metal may be plated between the anode current collector 21 and the anode interlayer 22. The average particle diameter of the lithiophilic metal may be a median diameter D50 measured by utilizing a laser particle size analyzer.

In one or more embodiments, the lithiophilic metal may include, for example, at least one selected from among gold (Au), platinum (Pt), palladium (Pd), silicon (Si), silver (Ag), aluminum (Al), bismuth (Bi), tin (Sn), and zinc (Zn). In some embodiments, the lithiophilic metal may include, for example, silver (Ag).

The carbonaceous material may allow substantially uniform application of the lithiophilic metal onto the anode current collector 21. The carbonaceous material may allow the lithiophilic metal to be uniformly applied onto the anode current collector 21, so that the anode current collector 21 may be uniformly coated with the lithiophilic metal. The lithiophilic metal uniformly applied thereto may allow substantially uniform plating of lithium metal on the anode current collector 21 to prevent or reduce formation of lithium dendrite.

In one or more embodiments, the carbonaceous material may include, for example, amorphous carbon, crystalline carbon, or any combination thereof. In some embodiments, the carbonaceous material may include, for example, amorphous carbon.

The amorphous carbon may include, for example, carbon black (CB), acetylene black (AB), furnace black (FB), Ketjen black (KB), graphene, or any combination thereof. Amorphous carbon may be carbon that does not have crystallinity or has very low crystallinity and is distinguished from crystalline carbon or graphite-based carbon.

In one or more embodiments, the anode interlayer 22 may include, for example, a lithiophilic metal and/or a carbonaceous material. The carbonaceous material may allow the lithiophilic metal to be substantially uniformly applied onto the anode current collector 21, and the lithiophilic metal may allow lithium metal to be uniformly plated between the anode interlayer 22 and the anode current collector 21. In one or more embodiments, formation of lithium dendrite may be inhibited, and thus lifespan characteristics of the lithium battery including the anode 20 may be improved. In one or more embodiments, the anode interlayer 22 may firmly bind the protective layer 24, which will be described elsewhere herein, to the plated lithium metal to inhibit deformation and perforation of the protective layer 24 caused by non-uniform plating of lithium metal.

In one or more embodiments, a mixing ratio of the lithiophilic metal to the carbonaceous material included in the anode interlayer 22 may be, for example, from about 10:1 to about 1:10, from about 10:1 to about 1:1, from about 10:1 to about 2:1, from about 5:1 to about 1:1, or from about 5:1 to about 2:1.

In one or more embodiments, the anode interlayer 22 may further include a binder. The binder included in the anode interlayer 22 may be, for example, at least one of styrene butadiene rubber (SBR), polytetrafluoroethylene, polyvinylidene fluoride, polyethylene, a vinylidene fluoride/hexafluoropropylene copolymer, polyacrylonitrile, or polymethylmethacrylate, but embodiments of the present disclosure are not limited thereto, for example, any binders commonly available in the art may also be utilized. The binder may be utilized alone or as a combination of a plurality of different binders. If (e.g., when) the anode interlayer 22 does not include a binder, the anode interlayer 22 may be easily separated from the protective layer 24 and/or from the anode current collector 21. an amount of the binder included in the anode interlayer 22 may be, for example, 5 wt % or less, from about 0.1 wt % to about 5 wt %, from about 0.1 wt % to about 3 wt %, or from about 0.1 wt % to about 1 wt % based on a total weight of the anode interlayer 22.

In one or more embodiments, a thickness of the anode interlayer may be, for example, from about 0.1 μm to about 5 μm, from about 0.1 μm to about 3 μm, from about 0.5 μm to about 5 μm, from about 0.5 μm to about 3 μm, or from about 0.5 μm to about 2 μm. If (e.g., when) the anode interlayer is too thin, lithium dendrite formed between the anode interlayer and the anode current collector may disintegrate the anode interlayer making it difficult to improve cycle characteristics of the lithium battery. If (e.g., when) the anode interlayer is too thick, energy density of the lithium battery including the anode 20 may decrease, making it difficult to improve cycle characteristics of thereof. As the thickness of the anode interlayer decreases, for example, a charging capacity of the anode interlayer may also decrease.

In one or more embodiments, a charging capacity of the anode interlayer may be, for example, from about 0.1% to about 50%, from about 1% to about 30%, from about 1% to about 10%, from about 1% to about 5%, or from about 1% to about 2% based on a total charging capacity of the lithium battery. If (e.g., when) the charging capacity of the anode interlayer is too low, lithium dendrites formed between the anode interlayer and the anode current collector may disintegrate the anode interlayer making it difficult to improve cycle characteristics of the lithium battery. If (e.g., when) the charging capacity of the anode interlayer is too high, energy density of the lithium battery including the anode 20 may decrease, making it difficult to improve cycle characteristics. The charging capacity of a cathode active material layer may be obtained by multiplying a charging capacity density (mAh/g) of a cathode active material by a mass of the cathode active material of the cathode active material layer. If (e.g., when) one or more suitable types (kinds) of cathode active materials are utilized, charging capacity density×mass values for all of the cathode active materials may be calculated respectively, and a sum of the values is regarded as the charging capacity of the cathode active material layer. The charging capacity of the anode interlayer may be calculated in substantially the same manner. For example, the charging capacity of the anode interlayer may be obtained by multiplying a charging capacity density (mAh/g) of the anode active material by a mass of the anode active material (e.g., lithiophilic metal and/or carbonaceous material) of the anode interlayer. If (e.g., when) one or more suitable types (kinds) of anode active materials are utilized, charging capacity density×mass values for all of the anode active materials may respectively be calculated and a sum of the values may be regarded as the charging capacity of the anode interlayer. For example, the charging capacity densities of the cathode active material and the anode active material may each be a capacity estimated utilizing an all-solid half-cell to which lithium metal is applied as a counter electrode. The charging capacities of the cathode active material layer and the anode interlayer may each directly be measured utilizing an all-solid half-cell. The charging capacity density may be calculated by dividing the measured charging capacity by the mass of each active material. In some embodiments, a charging capacity of the cathode active material layer and the anode interlayer may be an initial charging capacity measured during charging of a first cycle.

### Anode: Anode Active Material Layer

Referring to FIG. 2, in one or more embodiments, the anode 20 may further include an anode active material layer 23 between the anode current collector 21 and the protective layer 24. The anode active material layer 23 may include, for example, lithium metal and/or a lithium alloy.

In one or more embodiments, the anode active material layer 23 may include, for example, lithium foil, lithium powder, plated lithium, a carbonaceous material, or any combination thereof. In some embodiments, the anode active material layer including lithium foil may be, for example, a lithium metal layer. In some embodiments, the anode active material layer including lithium powder may be formed by applying a slurry including lithium powder and a binder onto the anode current collector. The binder may be a fluorine-based binder, such as polyvinylidene fluoride (PVDF). In some embodiments, the anode active material layer may not include (e.g., may exclude) a carbonaceous anode active material. Therefore, the anode active material layer may be formed of a metal-based anode active material. In some embodiments, the anode active material layer 23 may be a plated lithium metal layer. After preparing a lithium battery by assembling the anode 20 not including the anode active material layer 23, a cathode, and an electrolyte, a plated lithium metal layer, as the anode active material layer 23, may be formed between the anode current collector 21 and the anode interlayer 22 by charging.

In one or more embodiments, a thickness of the anode active material layer 23 may be, for example, from about 0.1 μm to about 100 μm, from about 0.1 μm to about 80 μm, from about 1 μm to about 80 μm, or from about 10 μm to about 80 μm, but embodiments of the present disclosure are not limited thereto, and may be adjusted in accordance with shape, capacity, and/or the like of the lithium battery. If (e.g., when) the anode active material layer 23 is too thick, structural stability of the lithium battery may deteriorate and side reactions may increase. If (e.g., when) the anode active material layer 23 is too thin, energy density of the lithium battery may decrease. In some embodiments, a thickness of the lithium foil may be, for example, from about 1 μm to about 50 μm, from about 1 μm to about 30 μm, or from about 10 μm to about 30 μm, or from about 10 μm to about 80 μm. If (e.g., when) the lithium foil has a thickness within the ranges described above, lifespan characteristics of the lithium battery including the protective layer may further be improved. In some embodiments, a particle diameter of lithium powder may be, for example, from about 0.1 μm to about 3 μm, from about 0.1 μm to about 2 μm, or from about 0.1 μm to about 2 μm. If (e.g., when) the lithium powder has a thickness within the ranges described above, lifespan characteristics of the lithium battery including the protective layer may further be improved. In some embodiments, a thickness of the plated lithium layer may be, for example, from about 1 μm to about 80 μm, or from about 10 μm to about 80 μm.

### Lithium Battery

A lithium battery according to one or more embodiments may include: a cathode; the anode; and an electrolyte between the cathode and the anode. The lithium battery may have increased capacity and excellent or suitable lifespan characteristics by including the anode of the present disclosure.

The lithium battery may be, for example, a lithium primary battery, a lithium secondary battery, a lithium-sulfur battery, or a lithium-air battery, but embodiments of the present disclosure are not limited thereto, and any lithium metal batteries available in the art may also be utilized.

Although the lithium battery may be prepared, for example, by the following method, the method is not limited thereto and may be adjusted according to required conditions.

### Anode

The anode of one or more embodiments is prepared.

### Cathode

First, a cathode active material composition may be prepared by mixing a cathode active material, a conductive material, a binder, and a solvent. The prepared cathode active material composition may directly be applied onto an aluminum current collector (i.e., as a cathode current collector) and dried to prepare a cathode plate on which a cathode active material layer is formed. In some embodiments, a cathode plate on which a cathode active material layer may be formed may be prepared by casting the cathode active material composition on a separate support and laminating a film separated from the support on an aluminum current collector.

The cathode active material may be any lithium-containing metal oxide utilized in the art without limitation. For example, in one or more embodiments, the cathode active material may include at least one composite oxide of lithium and a metal selected from among cobalt, manganese, nickel, and one or more combinations thereof, and non-limiting examples thereof may be a compound represented by one selected from the following formulae: LiₐA_{1-b}B′_{b}D₂ (wherein 0.90≤a≤1 and 0≤b≤0.5); LiₐE_{1-b}B′_{b}O_{2-c}D_{c} (wherein 0.90≤a≤1, 0≤b=0.5, and 0≤c≤0.05); LiE_{2-b}B′_{b}O_{4-c}D_{c} (wherein 0≤b≤0.5 and 0≤c≤0.05); LiₐNi_{1-b-c}Co_{b}B′_{c}D_{α} (wherein 0.90≤a≤1, 0≤b≤0.5, 0≤c≤0.05, and 0<α≤2); LiₐNi_{1-b-c}Co_{b}B′_{c}O_{2-α}F′_{α} (wherein 0.90≤a≤1, 0≤b≤0.5, 0≤c≤0.05, and 0<α<2); LiₐNi_{1-b-c}Co_{b}B′_{c}O_{2-α}F′₂ (wherein 0.90≤a≤1, 0≤b≤0.5, 0≤c=0.05, and 0<α<2); LiₐNi_{1-b-c}Mn_{b}B′_{c}D_{α} (wherein 0.90≤a≤1, 0≤b≤0.5, 0≤c≤0.05, and 0<α≤2); LiₐNi_{1-b-c}Mn_{b}B′_{c}O_{2-α}F′_{α} (wherein 0.90≤a≤1, 0≤b≤0.5, 0≤c≤0.05, and 0<α<2); LiₐNi_{1-b-c}Mn_{b}B_{c}O_{2-α}F′₂ (wherein 0.90≤a≤1, 0≤b≤0.5, 0≤c≤0.05, and 0<α<2); LiₐNi_{b}E_{c}G_{d}O₂ (wherein 0.90≤a≤1, 0≤b≤0.9, 0≤c≤0.5, and 0.001≤d≤0.1); LiₐNi_{b}Co_{c}Mn_{d}GₑO₂ (wherein 0.90≤a≤1, 0≤b≤0.9, 0≤c≤0.5, 0≤d≤0.5, and 0.001≤e≤0.1); LiₐNiG_{b}O₂ (wherein 0.90≤a≤1 and 0.001≤b≤0.1); LiₐCoG_{b}O₂ (wherein 0.90≤a≤1 and 0.001≤b≤0.1); LiaMnGbO2 (wherein 0.90≤a≤1 and 0.001≤b≤0.1); LiₐMn₂G_{b}O₄ (wherein 0.90≤a≤1 and 0.001≤b≤0.1); QO₂; QS₂; LiQS₂; V₂O₅; LiV₂O₅; LiI′O₂; LiNiVO₄; Li_{(3-f)}J₂(PO₄)₃ (wherein 0≤f≤2); Li_{(3-f)}Fe₂(PO₄)₃ (wherein 0≤f≤2); and LiFePO₄.

In the formulae representing compounds above, A may be Ni, Co, Mn, or any combination thereof; B′ may be Al, Ni, Co, Mn, Cr, Fe, Mg, Sr, V, a rare earth element, or any combination thereof; D may be O, F, S, P, or any combination thereof; E may be Co, Mn, or any combination thereof; F′ may be F, S, P, or any combination thereof; G may be Al, Cr, Mn, Fe, Mg, La, Ce, Sr, V, or any combination thereof; Q may be Ti, Mo, Mn, or any combination thereof; I′ may be Cr, V, Fe, Sc, Y, or any combination thereof; and J may be V, Cr, Mn, Co, Ni, Cu, or any combination thereof. The above-described compound (e.g., in the form of particles) having a coating layer on the surface thereof may also be utilized or a mixture of the above-described compound and a compound (e.g., in the form of particles) having a coating layer may also be utilized. The coating layer added to the surface of the compound may include, for example, a compound of a coating element such as an oxide, hydroxide, oxyhydroxide, oxycarbonate, or hydroxycarbonate of the coating element. The compound constituting the coating layer may be amorphous or crystalline. The coating element included in the coating layer may be Mg, Al, Co, K, Na, Ca, Si, Ti, V, Sn, Ge, Ga, B, As, Zr, or any mixture thereof. A method of providing the coating layer may be selected from those not adversely affecting physical properties of the cathode active material. The coating methods may be, for example, spray coating and/or dip coating. These methods may be obvious to those of ordinary skill in the art, and thus detailed descriptions thereof will not be given.

In some embodiments, the cathode active material may be, for example, LiₐNiₓCo_{y}M_{z}O_{2-b}A_{b} (wherein 1.0≤a≤1.2, 0≤b≤0.2, 0.8≤x<1, 0<y≤0.3, 0<z≤0.3, x+y+z=1, M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or any combination thereof, and A is fluorine (F), sulfur (S), chlorine (Cl), bromine (Br), or any combination thereof), LiNiₓCo_{y}Mn_{z}O₂ (wherein 0.8≤x≤0.95, 0≤y≤0.2, 0<z≤0.2, and x+y+z=1), LiNiₓCo_{y}Al_{z}O₂ (wherein 0.8≤x≤0.95, 0≤y≤0.2, 0<z≤0.2, and x+y+z=1), LiNiₓCo_{y}Mn_{z}Al_{w}O₂ (wherein 0.8≤x≤0.95, 0≤y≤0.2, 0<z≤0.2, 0<w≤0.2, and x+y+z+w=1), LiₐCoₓM_{y}O_{2-b}A_{b} (wherein 1.0≤a≤1.2, 0≤b≤0.2, 0.9≤x≤1, 0≤y≤0.1, x+y=1, M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or any combination thereof, and A is F, S, Cl, Br, or any combination thereof), LiₐNiₓMn_{y}M′_{z}O_{2-b}A_{b} (wherein 1.0≤a≤1.2, 0≤b≤0.2, 0<x≤0.3, 0.5≤y<1, 0<z≤0.3, x+y+z=1, M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or any combination thereof, and A is F, S, Cl, Br, or any combination thereof), LiₐM1ₓM2_{y}PO_{4-b}X_{b} (wherein 0.90≤a≤1.1, 0≤x≤0.9, 0≤y≤0.5, 0.9<x+y<1.1, 0≤b≤2, M1 is chromium (Cr), manganese (Mn), iron (Fe), cobalt (Co), nickel (Ni), copper (Cu), zirconium (Zr), or any combination thereof, M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or any combination thereof, and X is O, F, S, P, or any combination thereof), LiₐM3_{z}PO₄ (wherein 0.90≤a≤1.1, 0.9≤z≤1.1, and M3 is chromium (Cr), manganese (Mn), iron (Fe), cobalt (Co), nickel (Ni), copper (Cu), zirconium (Zr), or any combination thereof), or any combination thereof.

The conductive material may be at least one selected from among, but is not limited to, carbon black, graphite particulates, natural graphite, artificial graphite, acetylene black, Ketjen black, carbon fiber; carbon nanotubes; metal such as copper, nickel, aluminum, and silver each of which is utilized in powder, fiber, or tube form; and/or conductive polymers such as polyphenylene derivatives, and any material commonly utilized in the art as conductive materials may also be utilized. In some embodiments, the cathode may not include (e.g., may exclude) a separate conductive material.

The binder may be a vinylidene fluoride/hexafluoropropylene copolymer, polyvinylidene fluoride, polyacrylonitrile, polymethylmethacrylate, polytetrafluoroethylene (PTFE), or a mixture thereof, or a styrene butadiene rubber polymer. The solvent may be N-methylpyrrolidone (NMP), acetone, and/or water, but embodiments of the present disclosure are not limited thereto, and any solvent utilized in the art may also be utilized.

In some embodiments, a plasticizer or a pore forming agent may further be added to the cathode active material composition to form pores inside the electrode plate.

Contents of the cathode active material, the conductive material, the binder, and the solvent may be the same levels as those suitably utilized in lithium batteries. In some embodiments, at least one of the conductive material, the binder, or the solvent may not be provided (e.g., may be excluded) in accordance with a utilization and a configuration of the lithium battery.

In one or more embodiments, a content (e.g., amount) of the binder included in the cathode may be, for example, from about 0.1 wt % to about 10 wt % or from about 0.1 wt % to about 5 wt % based on a total weight of the cathode active material layer. A content (e.g., amount) of the cathode active material included in the cathode may be, for example, from about 80 wt % to about 99 wt %, from about 90 wt % to about 99 wt %, or from about 95 wt % to about 99 wt % based on the total weight of the cathode active material layer.

### Separator

Subsequently, a separator to be inserted between the cathode and the anode may be prepared.

Any separator utilized in the art for lithium batteries may be utilized. For example, any separator having low resistance to ion migration of the electrolyte and excellent or suitable electrolyte-retaining ability may be utilized. For example, in one or more embodiments, the separator may be selected from glass fiber, polyester, Teflon, polyethylene, polypropylene, polytetrafluoroethylene (PTFE), or any combination thereof, each of which is a non-woven or woven fabric. For example, a windable separator including polyethylene or polypropylene may be utilized in lithium-ion batteries, and a separator having excellent or suitable organic electrolyte-retaining ability may be utilized in lithium-ion polymer batteries.

The separator may be prepared according to the following example method. However, the method is not limited thereto and adjusted according to required conditions.

First, a polymer resin, a filler, and a solvent may be mixed to prepare a separator composition. The separator composition may directly be applied onto an electrode and dried to prepare a separator. In some embodiments, the separator composition may be cast on a support and dried and then a separator film separated from the support is laminated on an electrode to form the separator.

A polymer (e.g., a polymer resin) utilized to prepare the separator is not limited and any polymer utilized as a binder for electrode plates may also be utilized. For example, a vinylidene fluoride/hexafluoropropylene copolymer, a polyvinylidenefluoride (PVDF), polyacrylonitrile, polymethylmethacrylate, or any mixture thereof may be utilized.

### Electrolyte

Subsequently, an electrolyte may be prepared.

The electrolyte may be, for example, a liquid electrolyte, a solid electrolyte, or any combination thereof.

For example, in one or more embodiments, the electrolyte may be an organic electrolytic solution. The electrolytic solution may be prepared, for example, by dissolving a lithium salt in an organic solvent.

Any organic solvent utilized in the art may be utilized. For example, in one or more embodiments, the organic solvent may be propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethyl formamide, dimethyl acetamide, dimethylsulfoxide, dioxane, 1,2-dimethoxyethane, sulfolane, dichloroethane, chlorobenzene, nitrobenzene, diethylene glycol, dimethyl ether, or any mixture thereof.

The lithium salt may be any lithium salt utilized in the art. For example, in one or more embodiments, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein 1≤x≤20 and 1≤y≤20), LiCl, LiI, or any mixture thereof. A concentration of the lithium salt may be, for example, from about 0.1 M to about 5.0 M.

The solid electrolyte may be, for example, an oxide-based solid electrolyte, a sulfide-based solid electrolyte, or any combination thereof.

In one or more embodiments, the solid electrolyte may be, for example, an oxide-based solid electrolyte. The oxide-based solid electrolyte may include, for example, at least one selected from among Li_{1+x+y}AlₓTi₂₋ₓSi_{y}P_{3-y}O₁₂ (wherein 0<x<2 and 0≤y<3), BaTiO₃, Pb(Zr,Ti)O₃ (PZT), Pb₁₋ₓLaₓZr_{1-y}Ti_{y}O₃ (PLZT, where 0≤x<1 and 0≤y<1), Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (wherein 0<x<2 and 0<y<3), LiₓAl_{y}Ti_{z}(PO₄)₃ (wherein 0<x<2, 0<y<1, and 0<z<3), Li_{1+x+y}(Al, Ga)ₓ(Ti, Ge)₂₋ₓSi_{y}P_{3-y}O₁₂ (wherein 0≤x≤1 and 0≤y≤1), LiₓLa_{y}TiO₃ (wherein 0<x<2 and 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (wherein M=Te, Nb, or Zr, and x is an integer from 1 to 10). The solid electrolyte may be manufactured by a sintering method, and/or the like. For example, in some embodiments, the oxide-based solid electrolyte may be a garnet-type or kind solid electrolyte selected from Li₇La₃Zr₂O₁₂ (LLZO) and Li₃₊ₓLa₃Zr₂₋ₐMₐO₁₂ (M doped LLZO, wherein M=Ga, W, Nb, Ta, or Al and x is an integer from 1 to 10).

For example, in one or more embodiments, the solid electrolyte may include at least one selected from among lithium sulfide, silicon sulfide, phosphorous sulfide, boron sulfide, or any combination thereof. In some embodiments, sulfide-based solid electrolyte particles may include Li₂S, P₂S₅, SiS₂, GeS₂, B₂S₃ or any combination thereof. In some embodiments, sulfide-based solid electrolyte particles may be Li₂S or P₂S₅. Sulfide-based solid electrolyte particles are suitable to have higher lithium ion conductivity than other inorganic compounds. For example, in some embodiments, the sulfide-based solid electrolyte may include Li₂S and P₂S₅. If (e.g., when) a sulfide solid electrolyte material constituting the sulfide-based solid electrolyte includes Li₂S—P₂S₅, a mixing molar ratio of Li₂S to P₂S₅ may be, for example, in the range of about 50:50 to about 90:10. In some embodiments, an inorganic solid electrolyte prepared by adding Li₃PO₄, a halogen, a halogen compound, Li₂₊₂ₓZn₁₋ₓGeO₄ (“LISICON”, where 0≤x<1), Li_{3+y}PO₄₋ₓNₓ (“LIPON”, where 0<x<4 and 0<y<3), Li_{3.25}Ge_{0.25}P_{0.75}S₄ (“Thio-LISICON”), Li₂O—Al₂O₃—TiO₂—P₂O₅ (“LATP”), and/or the like to an inorganic solid electrolyte such as Li₂S—P₂S₅, SiS₂, GeS₂, B₂S₃, or any combination thereof may be utilized as the sulfide-based solid electrolyte. Examples of the sulfide-based solid electrolyte material may include, but are not limited to, Li₂S—P₂S₅; Li₂S—P₂S₅—LiX (wherein X is a halogen); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (wherein 0<m<10, 0<n<10, and Z=Ge, Zn or Ga); Li₂S—GeS₂; Li₂S—SiS₂—Li₃PO₄; and/or Li₂S—SiS₂—LiₚMO_{q} (wherein 0<p<10, 0<q<10, and M=P, Si, Ge, B, Al, Ga, or In). In this regard, the sulfide-based solid electrolyte material may be manufactured by treating starting materials (e.g., Li₂S and P₂S₅) of the sulfide-based solid electrolyte by a melt quenching method, a mechanical milling method, and/or the like. Also, a calcination process may further be performed after the above process. The sulfide-based solid electrolyte may be in an amorphous form or a crystalline form or in a mixed form thereof.

### Lithium Battery

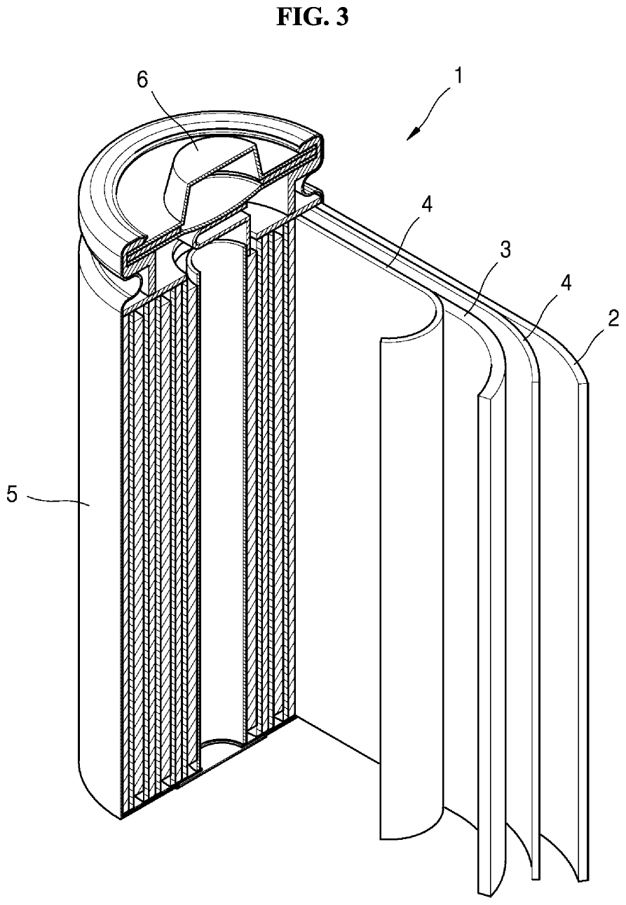

Referring to FIG. 3, a lithium battery 1 according to one or more embodiments may include a cathode 3, the anode 2 of the present disclosure, and a separator 4. The cathode 3, the anode 2, and the separator 4 may be wound or folded to form a battery assembly. The formed battery assembly may be accommodated in a battery case 5. An organic electrolytic solution may be injected into the battery case 5, and the battery case 5 may be sealed with a cap assembly 6 to complete preparation of the lithium battery 1. The battery case 5 may be a cylindrical type or kind, but is not limited thereto, and may be for example, a rectangular type or kind or a thin film type or kind.

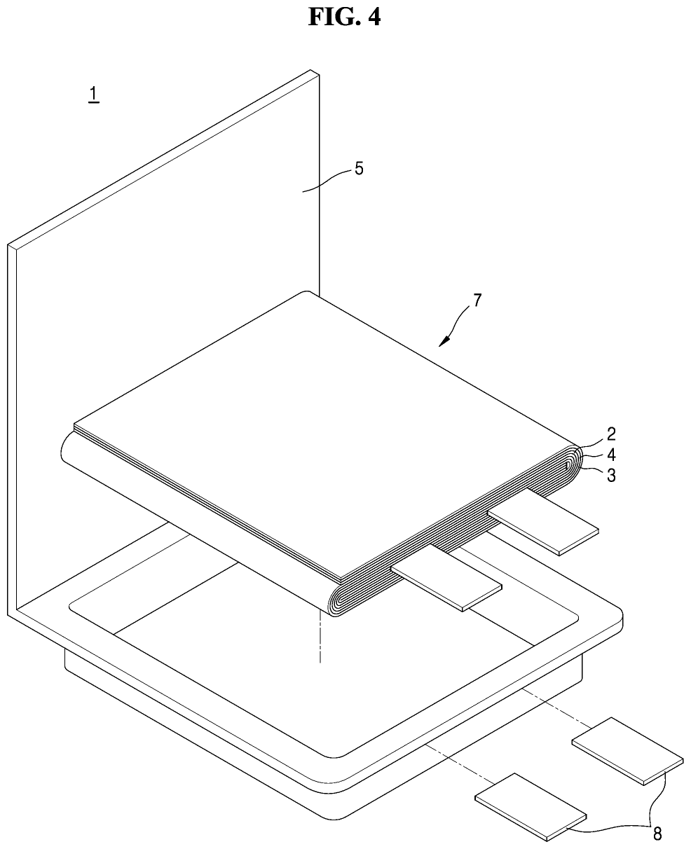

Referring to FIG. 4, a lithium battery 1 according to one or more embodiments may include a cathode 3, the anode 2 of the present disclosure, and a separator 4. The separator 4 may be disposed between the cathode 3 and the anode 2, and the cathode 3, the anode 2, and the separator 4 may be wound or folded to form a battery assembly 7. The formed battery assembly 7 may be accommodated in a battery case 5. The lithium battery 1 may include an electrode tab 8 serving as an electrical passage for inducing a current generated in the battery assembly 7 to the outside. An organic electrolytic solution may be injected into the battery case 5, and the battery case 5 may be sealed to complete preparation of the lithium battery 1. The battery case 5 may be a rectangular type or kind, but is not limited thereto, and for example, a cylindrical type or kind or a thin film type or kind may also be utilized.

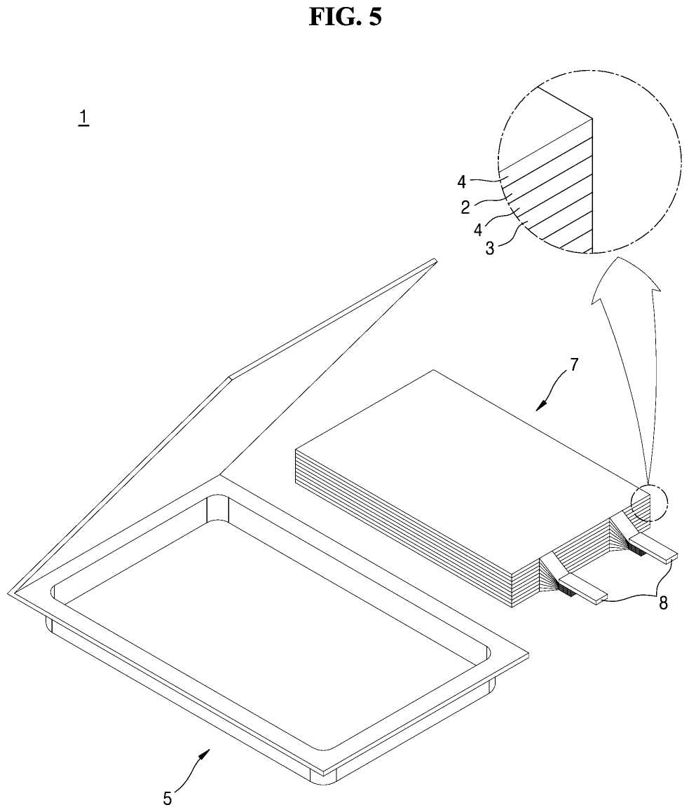

Referring to FIG. 5, a lithium battery 1 according to one or more embodiments may include a cathode 3, the anode 2 of the present disclosure, and a separator 4. The separator 4 may be disposed between the cathode 3 and the anode 2 to form a battery assembly 7. The battery assembly 7 may be stacked in a bi-cell structure and accommodated in a battery case 5. The lithium battery 1 may include an electrode tab 8 serving as an electrical passage for inducing a current generated in the battery assembly 7 to the outside. An organic electrolytic solution may be injected into the battery case 5, and the battery case 5 may be sealed to complete preparation of the lithium battery 1. The battery case 5 may be a rectangular type or kind, but is not limited thereto, and for example, a cylindrical type or kind or a thin film type or kind may also be utilized.

In a pouch-type or kind lithium battery, a pouch may be utilized as the battery case of each of the lithium batteries shown in FIGS. 3 to 5. A pouch-type or kind lithium battery may include at least one battery assembly. The separator may be disposed/placed between the cathode and the anode to form a battery assembly. The battery assembly may be stacked in a bi-cell structure, impregnated with an organic electrolytic solution, accommodated in a pouch, and sealed to complete preparation of the pouch-type or kind lithium battery. For example, in some embodiments, the cathode, the anode, and the separator may be simply stacked in a battery assembly and accommodated in a pouch. In some embodiments, the cathode, the anode, and the separator may be wound in a jelly-roll form or folded in a battery assembly and accommodated in a pouch. Subsequently, an organic electrolytic solution may be injected into the pouch, and the pouch may be sealed to complete preparation of the lithium battery.

Due to excellent or suitable lifespan characteristics and high-rate characteristics, lithium batteries may be utilized, for example, in electric vehicles (EVs). For example, lithium batteries may be utilized in hybrid vehicles such as plug-in hybrid electric vehicles (PHEVs). In some embodiments, lithium batteries may be utilized in the fields requiring a large amount of power storage. For example, lithium batteries may be utilized in E-bikes and/or electric tools.

A plurality of lithium batteries may be stacked to form a battery module, and a plurality of battery modules may constitute a battery pack. Such battery packs may be utilized in any device that requires high capacity and high output. For example, battery packs may be utilized in laptop computers, smart phones, and electric vehicles. For example, a battery module may include a plurality of batteries and a frame holding the batteries. The battery pack may include, for example, a plurality of battery modules and a bus bar connecting the battery modules. The battery module and/or the battery pack may further include a cooling device. The plurality of battery packs may be controlled or selected by a battery management system. The battery management system may include a battery pack, and a battery control device connected to the battery pack.

### Method of Preparing Binder

A method of manufacturing a binder according to one or more embodiments may include preparing a third composition by mixing a first composition including a first polymer including a first functional group and at least one selected from among polyamic acid and polyimide substituted with fluorine and a non-aqueous solvent with a second composition including a water-soluble second polymer including a second functional group and water; and heat-treating the third composition at a temperature of 100° C. or above to prepare a third polymer.

The first polymer, the second polymer, and the third polymer are as described above in the binder. The non-aqueous solvent included in the first composition may be a polar solvent such as N—N-methylpyrrolidone (NMP) and/or alcohol. In some embodiments, the first composition may further include water. Although the second composition is an aqueous solution including water, a polar organic solvent such as alcohol that is miscible with water may further be added thereto. Therefore, the first composition may be easily mixed with the second composition. Although a heat treatment time of the third composition at a temperature of 100° C. or above is not limited, for example, in some embodiments, the third composition may be heat-treated at a temperature of 100° C. or above for about 1 hour to about 10 hours. For example, in some embodiments, the heat treatment time of the third composition at a temperature of 160° C. above may be from about 1 hour to about 5 hours. For example, in some embodiments, the heat treatment time of the third composition at a temperature of 100° C. above may be from about 1 hour to about 3 hours. If (e.g., when) the heat treatment time is too short, a cross-link may not be sufficiently formed. If (e.g., when) the heat treatment time is too long, the degree of cross-linking may be negligible relative to the heat treatment time. However, the heat treatment temperature is too low, polyamic acid may not be cured into polyimide.

In the method of manufacturing the binder, the third composition may be a protective layer-forming composition. Therefore, the protective layer may be formed concurrently (e.g., simultaneously) with preparing the anode by performing heat treatment at a temperature of 100° C. or above for about 1 hour to about 10 hours after applying the third composition onto the anode current collector. For example, in some embodiments, the protective layer may be formed concurrently (e.g., simultaneously) with preparing the anode by performing heat treatment at a temperature of 160° C. or above for about 1 hour to about 10 hours after applying the third composition onto the anode current collector.

In the method of manufacturing the binder, the first polymer may include an alkali metal. The first polymer may be substituted or doped with an alkali metal. For more descriptions of the first polymer substituted or doped with an alkali metal, refer to the above-described binder.

### Method of Manufacturing Anode

A method of manufacturing an anode according to one or more embodiments may include: providing an anode current collector; and providing a protective layer onto the anode current collector.

The protective layer may be formed by applying the third composition including the first polymer and the second polymer onto the anode current collector and performing heat treatment at a temperature of 100° C. or above for about 1 hour to about 10 hours.

In one or more embodiments, first, an anode current collector may be provided. For the anode current collector, reference may refer to the above-described anode. For example, in some embodiments, a copper foil may be provided as the anode current collector.

Subsequently, the protective layer may be provided on the anode current collector. The protective layer may be formed by a method including: preparing a third composition by mixing a first composition including a first polymer including a first functional group and at least one selected from among polyamic acid and polyimide substituted with fluorine and a non-aqueous solvent with a second composition including a water-soluble second polymer including a second functional group and water; and applying the third composition onto the anode current collector and heat-treating the third composition at a temperature of 100° C. or above to form the protective layer.

The first polymer, the second polymer, and the third polymer are the same as described above in the binder. The non-aqueous solvent included in the first composition may be a polar solvent such as N—N-methylpyrrolidone (NMP) and/or alcohol. In some embodiments, the first composition may further include water. Although the second composition is an aqueous solution including water, a polar organic solvent such as alcohol that is miscible with water may further be added thereto. Therefore, the first composition may be easily mixed with the second composition.

Although a heat treatment time of the third composition at a temperature of 100° C. or above is not limited, for example, in some embodiments, the third composition may be heat-treated at a temperature of 100° C. or above for about 1 hour to about 10 hours. For example, in some embodiments, after applying the third composition onto the anode current collector, the heat treatment performed at a temperature of 100° C. or above may be performed for about 1 hour to about 5 hours. For example, in some embodiments, after applying the third composition onto the anode current collector, the heat treatment performed at a temperature of 100° C. or above may be performed for about 1 hour to about 3 hours. If (e.g., when) the heat treatment time is too short, a cross-link may not be sufficiently formed. If (e.g., when) the heat treatment time is too long, the degree of cross-linking may be negligible relative to the heat treatment time. However, if (e.g., when) the heat treatment temperature is too low, polyamic acid may not be cured into polyimide.

In one or more embodiments, the method of manufacturing the anode may further include introducing an anode interlayer between the anode protective layer (i.e., the protective layer) and the anode current collector. The anode interlayer may include a lithiophilic metal. The anode interlayer may include a lithiophilic metal and/or a carbonaceous material. The lithiophilic metal and the carbonaceous material are the same as described above in the anode interlayer. For example, in some embodiments, the anode interlayer may be formed on the anode current collector by applying nanoparticles including the lithiophilic metal onto the anode current collector by nanoparticle casting. In some embodiments, the anode interlayer may be provided, for example, by preparing a first slurry by mixing a lithiophilic metal with a solvent, and applying to the first slurry onto the anode current collector and drying the first slurry. The solvent may be an organic solvent. The solvent may be, for example, N,N-dimethylacetamide, N—N-methylpyrrolidone (NMP), and/or the like, but is not limited thereto, and may be any solvents utilized in the art. In some embodiments, the first slurry may further include a carbonaceous material.

In one or more embodiments, the method of manufacturing the anode may further include introducing an anode active material layer between the protective layer and the anode current collector. The anode active material layer may include, for example, lithium metal and/or a lithium alloy.

A method of introducing the anode active material layer between the protective layer and the anode current collector is not limited. For example, in some embodiments, an anode active material layer may be disposed/provided on the anode current collector before providing the protective layer onto the anode current collector. A method for disposing the anode active material layer on the anode current collector is not limited. For example, in some embodiments, the lithium metal layer may be disposed/provided on the anode current collector by sputtering, and/or the like. In some embodiments, a lithium foil may be disposed/provided on the anode current collector and rolled. In some embodiments, a commercially available stack structure in which a lithium metal layer is stacked on a copper foil may be utilized. For example, in some embodiments, a stack structure may be prepared by coating a metal substrate with a composition including lithium powder and a binder and drying the coated composition. For the lithium powder and the binder, reference may refer to the above-described anode. In some embodiments, after preparing an anode including an anode current collector and a protective layer, and an anode active material layer may be introduced between the anode current collector and the protective layer by charging. The anode active material layer may be, for example, a plated lithium layer.

Hereinafter, one or more embodiments of the present disclosure will be described in more detail with reference to the following examples and comparative examples. However, these examples are not intended to limit the purpose and scope of the one or more embodiments.

### Preparation of Cross-Linked Polymer

### Preparation Example 1: PI—F

After filling a three-neck round bottom flask with nitrogen, 9.9790 g (0.0498 mol) of 2,2′-bis(trifluoromethyl)benzidine (TFMB) and 2.5275 g (0.0166 mol) of 1,3-diaminobenzoic acid (DABA) were added thereto, and then 153 g of N—N-methylpyrrolidone (NMP) was added thereto and completely dissolved therein by utilizing a mechanical stirrer. Subsequently, 14.4935 g (0.0664 mol) of 4,4′-(hexafluoroisopropylidene)diphthalic anhydride (6FDA) was added thereto and stirred at room temperature for 24 hours to prepare fluorine-substituted polyamic acid (6FDA/TFMB/DABA, an acid equivalent of 210 g/eq, and a weight average molecular weight Mw of about 1,000,000) represented by Formula 17. The fluorine-substituted polyamic acid is a random copolymer. A molar ratio of 6FDA:TFMB:DABA was 4:3:1. In Formulae 17 and 18, a molar ratio of m:n was 1:3.

### Preparation Example 2: LiPI—F

After filling a three-neck round bottom flask with nitrogen, 9.9790 g (0.0498 mol) of 2,2′-bis(trifluoromethyl)benzidine (TFMB) and 2.5275 g (0.0166 mol) of 1,3-diaminobenzoic acid (DABA) were added thereto, and then 153 g of N—N-methylpyrrolidone (NMP) was added thereto and completely dissolved therein by utilizing a mechanical stirrer. Subsequently, 14.4935 g (0.0664 mol) of 4,4′-(hexafluoroisopropylidene)diphthalic anhydride (6FDA) was added thereto and stirred at room temperature for 24 hours to prepare fluorine-substituted polyamic acid (6FDA/TFMB/DABA, an acid equivalent of 210 g/eq, and a weight average molecular weight Mw of about 1,000,000) represented by Formula 17. The fluorine-substituted polyamic acid was a random copolymer. A molar ratio of 6FDA:TFMB:DABA was 4:3:1. In Formulae 17 and 18, a molar ratio of m:n was 1:3.

10 g of an LiOH aqueous solution in an equivalence ratio (e.g., molar ratio) of 0.5 to carboxylic acid was added to the fluorine-substituted polyamic acid represented by Formula 17 (6FDA/TFMB/DABA, an acid equivalent of 210 g/eq, a weight average molecular weight Mw of about 1,000,000) to prepare fluorine-substituted water-soluble polyamic acid represented by Formula 18 in which 0.5 eq. of —COOH groups, among all —COOH groups of the fluorine-substituted polyamic acid, were substituted with —COO—Li⁺ groups. The fluorine-substituted water-soluble polyamic acid represented by Formula 18 and polyvinylalcohol (a weight average molecular weight Mw of 78,000, a saponification degree of 88%, and Polysciences, 15132) were mixed in a weight ratio of 20:80 and heat-treated in a vacuum oven at 180° C. for 2 hours for cross-linking reaction, thereby preparing a cross-linked polymer. As the carboxyl group of the fluorine-substituted polyamic acid reacted with the hydroxyl group of polyvinylalcohol to form an ester linker, the cross-linked polymer of the fluorine-substituted polyimide and the polyvinylalcohol was prepared. The cross-linked polymer had a three-dimensional network structure in which polyimide is cross-linked to polyvinylalcohol at a plurality of sites.

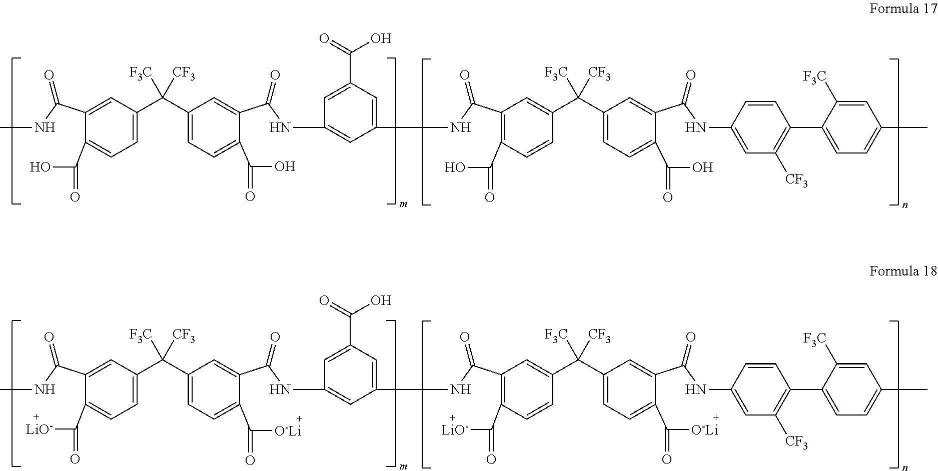

### Comparative Preparation Example 1: PI

Polyamic acid represented by Formula 19 was prepared in substantially the same manner as in Example 1, except that 2,2′-dimethylbenzidine, which did not include fluorine, was utilized instead of 2,2′-bis(trifluoromethyl)benzidine and 4,4′-(isopropylidene)diphthalic anhydride, which did not include fluorine, was utilized instead of 4,4′-(hexafluoroisopropylidene)diphthalic anhydride in comparison with Example 1.

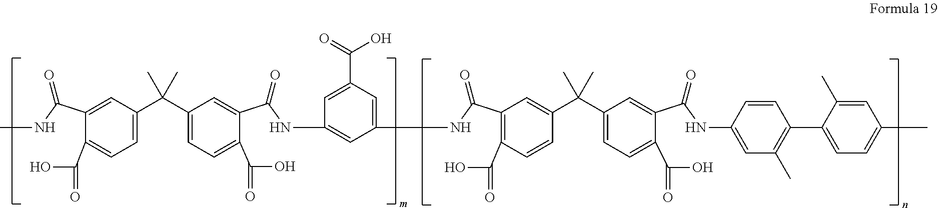

### Comparative Preparation Example 2: PVA

Polyvinylalcohol utilized in Example 1 was utilized.

### Comparative Preparation Example 3: SBR/CMC

A mixture of styrene butadiene rubber (SBR) and carboxymethyl cellulose (CMC) mixed in a weight ratio of 1:1 was prepared.

### Preparation of Anode and Lithium Battery

### Example 1: Cu Substrate/PI—F:PVA=20:80 Protective Layer (1 μm)

### Preparation of Anode

The fluorine-substituted polyamic acid represented by Formula 17 and prepared in Preparation Example 1 was added to N,N-dimethyl acetamide (DMAc, 99%, Sigma-Aldrich) and stirred overnight at 60° C. to prepare a first composition.

Polyvinylalcohol (weight average molecular weight Mw of 78,000, a saponification degree of 88%, and Polysciences, 15132) was added to N,N-dimethyl acetamide (DMAc, 99%, Sigma-Aldrich) and stirred overnight at 60° C. to prepare a second composition.

The first composition was mixed with the second composition such that a weight ratio of the fluorine-substituted polyamic acid to the polyvinylalcohol was 20:80 to prepare a third composition.

Subsequently, heat treatment was performed in a vacuum oven at 180° C. for 2 hours for cross-linking reaction to prepare a cross-linked polymer. As the carboxyl group of the fluorine-substituted polyamic acid reacted with the hydroxyl group of polyvinylalcohol to form an ester linker, the cross-linked polymer of the fluorine-substituted polyimide and the polyvinylalcohol was prepared The cross-linked polymer had a three-dimensional network structure in which polyimide is cross-linked to polyvinylalcohol at a plurality of sites.

The third composition was applied to a 20 μm-thick copper (Cu) current collector by utilizing a doctor blade, and the solvent was removed therefrom at 140° C. for 6 hours to introduce a protective layer.

An anode having an anode current collector/protective layer structure was prepared. The protective layer had a thickness of 1 μm.

### Preparation of Coin Cell

A coin cell was prepared by utilizing a 20 μm-thick lithium foil as a counter electrode, disposing a polypropylene separator (Celgard 3510) between the counter electrode and the anode, and injecting an electrolyte thereinto.

A solution of 1.15 M LiPF₆ dissolved in a mixed solvent of ethylene carbonate (EC)+ ethylmethyl carbonate (EMC)+dimethyl carbonate (DMC) (volume ratio of 2:4:4) was utilized as the electrolyte.

### Example 2: Cu Substrate/PI—F:PVA=20:80 Protective Layer (0.5 μm)

A coin cell was prepared in substantially the same manner as in Example 1, except that the thickness of the protective layer was 0.5 μm.

### Example 3: Cu Substrate/PI—F:PVA=20:80 Protective Layer (0.3 μm)

A coin cell was prepared in substantially the same manner as in Example 1, except that the thickness of the protective layer was 0.3 μm.

### Example 4: Cu Substrate/PI—F:PVA=20:80 Protective Layer (1.5 μm)

A coin cell was prepared in substantially the same manner as in Example 1, except that the thickness of the protective layer was 1.5 μm.

### Example 5: Cu Substrate/PI—F:PVA=20:80 Protective Layer (3 μm)

A coin cell was prepared in substantially the same manner as in Example 1, except that the thickness of the protective layer was 3 μm.

### Example 6: Cu Substrate/PI—F:PVA=20:80 Protective Layer (5 μm)

A coin cell was prepared in substantially the same manner as in Example 1, except that the thickness of the protective layer was 5 μm.

### Example 7: Cu Substrate/LiPI—F:PVA=20:80 Protective Layer (1 μm)

A coin cell was prepared in substantially the same manner as in Example 1, except that the fluorine-substituted water-soluble polyamic acid represented by Formula 18 and prepared in Preparation Example 2 was utilized instead of the fluorine-substituted polyamic acid represented by Formula 17 and prepared in Preparation Example 1.

### Comparative Example 1: Cu Substrate/PI:PVA=20:80 Protective Layer (1 μm)

A coin cell was prepared in substantially the same manner as in Example 1, except that the polyamic acid represented by Formula 19 and prepared in Comparative Preparation Example 1 was utilized instead of the fluorine-substituted polyamic acid represented by Formula 17 and prepared in Preparation Example 1.

### Comparative Example 2: Cu Substrate/PVA Protective Layer (1 μm)

A coin cell was prepared in substantially the same manner as in Example 1, except that the polyvinyl alcohol prepared in Comparative Preparation Example 2 was utilized instead of the fluorine-substituted polyamic acid represented by Formula 17 and prepared in Preparation Example 1.

### Comparative Example 3: Cu Substrate/SBR-CMC Protective Layer (1 μm)

A coin cell was prepared in substantially the same manner as in Example 1, except that SBR-CMC prepared in Comparative Preparation Example 3 was utilized instead of the fluorine-substituted polyamic acid represented by Formula 17 and prepared in Preparation Example 1.

### Comparative Example 4: Cu Substrate/Protective Layer-Free

A coin cell was prepared in substantially the same manner as in Example 1, except that the anode did not include a protective layer.

### Evaluation Example 1: Evaluation of Physical Properties of Protective Layer

After preparing a polymer film with a size of 5×5 cm² and a thickness of 50 μm on a glass substrate by utilizing each of the protective layers prepared in Example 1 and Comparative Examples 1 to 3, mechanical properties of each of the polymers were evaluated as follows.

Extension, recovery, modulus, and hardness of each of the protective layers prepared in Example 1 and Comparative Examples 1 to 3 were measured by utilizing a microindenter (DUH-211, Shimadzu). A force applied to the polymer film sample was 10 mN.

Measurement results are shown in Table 1. The extension is a distance of a tip of the microindenter moved into the sample until a constant force is applied to the tip, and the recovery is a ratio of a distance of the tip moved in a direction toward the surface from a farthest point from the surface to a point at which the force applied to the tip was zero relative to the distance of the tip moved into the sample. The modulus was indentation modulus, and the hardness was indentation hardness, which were each calculated from the force applied to the tip of each sample in accordance with a moving direction of the tip of the microindenter.

TABLE 1

| | | Exten- | | | |
|---|---|---|---|---|---|
| | | sion | Recovery | Modulus | Hardness |
| | Type | [mm] | [%] | [GPa] | [N/mm2] |
| Example 1 | PI-F:PVA = | 0.39 | 68.6 | 38.1 | 1578 |
| | 20:80 | | | | |
| Comparative | PI:PVA = | 0.37 | 65.3 | 34.3 | 1754 |
| Example 1 | 20:80 | | | | |
| Comparative | PI:PVA = | 0.33 | 66.5 | 29.5 | 1695 |
| Example 2 | 0:100 | | | | |
| Comparative | SBR/CMC | 1.23 | 53.9 | 4.2 | 169 |
| Example 3 | | | | | |

As shown in Table 1, the protective layer of Example 1 had increased stiffness of the binder because the modulus, i.e., Young's modulus, was greater than that of each of the protective layers of Comparative Examples 1 to 3, and thus expansion of the anode was inhibited.

### Evaluation Example 2: Evaluation of Charging/Discharging Characteristics

Each of the lithium batteries (coin cells) prepared in Examples 1 to 7 and Comparative Examples 1 to 4 was charged at a constant current of 0.1 C rate at 25° C. until a voltage reached 0.01 V (vs. Li) and charged at a constant voltage of 0.01 V until the current reached 0.01 C. The charged lithium battery was rested for 10 minutes and discharged at a constant current of 0.1 C until the voltage reached 1.5 V (vs. Li) (1^{st} cycle).

Then, the lithium battery was charged at a constant current of 0.2 C rate until the voltage reached 0.01 V (vs. Li) and charged at a constant voltage of 0.01 V until the current reached 0.01 C. The charged coin cell was rested for 10 minutes and discharged at a constant current of 0.2 C until the voltage reached 1.5 V (vs. Li) (2^{nd} cycle) (1^{st} to 2^{nd} cycles correspond to formation process).

The coin cell that had undergone the formation process was charged at a constant current of 1.0 C rate at 25° C. until the voltage reached 0.01 V (vs. Li) and charged at a constant voltage of 0.01 V until the current reached 0.01 C. The charged coin cell was rested for 10 minutes and discharged at a constant current of 1.0 C until the voltage reached 1.5 V (vs. Li), and this cycle was repeated 50 times. Some results of the charging/discharging test were shown in Table 2.

Electrode thickness expansion rate, initial efficiency, and capacity retention ratio were calculated from Equations 1 to 3, respectively. In the electrode thickness expansion rate, the electrode was an anode.

$$Equation 1$$

$$Thickness expansion rate ( \% ) = [ \text{} Thickness of electrode of disassembled battery after charging at {2}^{nd} cycle / Thickness of electrode before assembling battery ] \times 100.$$

$$Equation 2$$

$$Initial efficiency [ \% ] = [ \text{} Discharging capacity at {1}^{st} cycle / Charging capacity at {1}^{st} cycle ] \times 100$$

$$Equation 3$$

$$Capacity retention ratio [ \% ] = [ Discharging \text{} capacity at {53}^{rd} cycle / Discharging capacity {3}^{rd} cycle ] \times 100$$

TABLE 2

| | | | | Discharge | | Electrode |
|---|---|---|---|---|---|---|
| | | | | capacity | Capacity | thickness |
| | Protective layer | | Initial | at 1^{st} | retention | expansion |
| | | Thickness | efficiency | cycle | ratio | rate |
| | Type | (μm) | [%] | [mAh/g] | [%] | [%] |
| Example 1 | PI-F:PVA = | 1 | 94.1 | 23.3 | 87.5 | 240 |
| | 20:80 | | | | | |
| Example 2 | PI-F:PVA = | 0.5 | 92.8 | 23.1 | 82.1 | 250 |
| | 20:80 | | | | | |
| Example 3 | PI-F:PVA = | 0.3 | 91.2 | 22.8 | 77.6 | 260 |
| | 20:80 | | | | | |
| Example 4 | PI-F:PVA = | 1.5 | 93.7 | 23.3 | 89.7 | 235 |
| | 20:80 | | | | | |
| Example 5 | PI-F:PVA = | 3 | 91.0 | 22.7 | 69.2 | 260 |
| | 20:80 | | | | | |
| Example 7 | LiPI-F:PVA = | 1 | 94.3 | 22.9 | 90.1 | 240 |
| | 20:80 | | | | | |
| Comparative | PI:PVA = | 1 | 90.8 | 21.2 | 85.4 | 330 |
| Example 1 | 20:80 | | | | | |
| Comparative | PI:PVA = | 1 | 10.5 | 5.3 | N/A | 350 |
| Example 2 | 0:100 | | | | | |
| Comparative | SBR/CMC | 1 | 55.9 | 17.7 | 65.5 | 410 |
| Example 3 | | | | | | |
| Comparative | No protective | — | 94.0 | 23.1 | 88.3 | 450 |
| Example 4 | layer | | | | | |

As shown in Table 2, in each of the lithium batteries of Examples 1 to 7, stable solid electrolyte interphase (SEI) was formed during initial plating, and thus the electrode thickness expansion rate decreased with maintained or improved initial efficiency and discharging capacity at the 1^{st} cycle, compared to the lithium batteries of Comparative Examples 1 to 4.

According to one or more embodiments, by utilizing the binder including the cross-linked polymer in which the fluorine-substituted polyamic acid or polyimide is cross-linked to the water-soluble binder, the lithium battery may have improved initial efficiency, lifespan characteristics, and electrode stability. Volume change of the lithium battery may also be inhibited.

In the present disclosure, it will be understood that the term “comprise(s),” “include(s),” or “have/has” specifies the presence of stated features, integers, steps, operations, elements, and/or components, but do not preclude the presence or addition of one or more other features, integers, steps, operations, elements, components, and/or groups thereof.

In present disclosure, “not include a or any ‘component’” “exclude a or any ‘component’”, “‘component’-free”, and/or the like refers to that the “component” not being added, selected or utilized as a component in the composition/element, but, in some embodiments, the “component” of less than a suitable amount may still be included due to other impurities and/or external factors.

Throughout the present disclosure, when a component such as a layer, a film, a region, or a plate is mentioned to be placed “on” another component, it will be understood that it may be directly on another component or that another component may be interposed therebetween. In some embodiments, “directly on” may refer to that there are no additional layers, films, regions, plates, etc., between a layer, a film, a region, a plate, etc. and the other part. For example, “directly on” may refer to two layers or two members are disposed without utilizing an additional member such as an adhesive member therebetween.

In the present disclosure, although the terms “first,” “second,” etc., may be utilized herein to describe one or more elements, components, regions, and/or layers, these elements, components, regions, and/or layers should not be limited by these terms. These terms are only utilized to distinguish one component from another component.

As utilized herein, the singular forms “a,” “an,” and “the” are intended to include the plural forms as well, unless the context clearly indicates otherwise. Further, the utilization of “may” when describing embodiments of the present disclosure may refer to “one or more embodiments of the present disclosure”.

As utilized herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

In the present disclosure, when particles or tubes are spherical or circular, “size” or “diameter” indicates a particle or tube diameter or an average particle or tube diameter, and when the particles or tubes are non-spherical or non-circular, the “size” or “diameter” indicates a major axis length or an average major axis length. For example, when particles are spherical, “diameter” indicates a particle diameter, and when the particles are non-spherical, the “diameter” indicates a major axis length. The size or diameter of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

The battery module, battery pack, battery management system, electric vehicle, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the drawings, it will be understood by those of ordinary skill in the art that one or more suitable changes in form and details may be made therein without departing from the spirit and scope of the present disclosure as defined by the appended claims and equivalents thereof.

What is claimed is:

1. A binder, the binder comprising a third polymer, the third polymer being a cross-linked product of a first polymer and a water-soluble second polymer,
wherein the first polymer comprises a first functional group and at least one selected from among polyamic acid and polyimide each substituted with fluorine, and the water-soluble second polymer comprises a second functional group, and
wherein the first polymer is cross-linked to the water-soluble second polymer by an ester bond formed via a reaction between the first functional group and the second functional group.

2. The binder as claimed in claim 1, wherein the first functional group and the second functional group are each independently selected from among a carboxyl group, an amide group, an aldehyde group, and a hydroxyl group.

3. The binder as claimed in claim 1, wherein the first polymer comprises an alkali metal.

4. The binder as claimed in claim 3, wherein an amount of the alkali metal in the first polymer is about 0.2 to about 1.0 in an equivalence ratio to a carboxyl group or an amide group.

5. The binder as claimed in claim 1, wherein the polyimide is represented by Formula 1 or Formula 2: 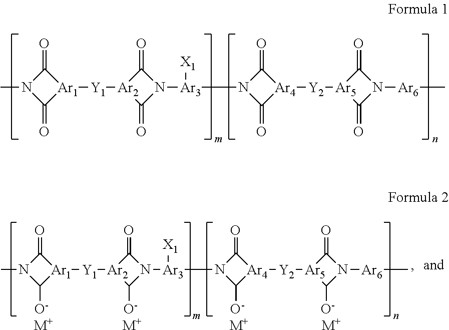
wherein in Formulae 1 and 2,
M is an alkali metal,
Ar₁, Ar₂, Ar₄, and Ar₅ are each independently an aromatic cyclic group selected from among: a trivalent C6-C24 arylene group unsubstituted or substituted with a halogen or a C1-C10 alkyl group unsubstituted or substituted with a halogen; and a trivalent C4-C24 heteroarylene group unsubstituted or substituted with a halogen or a C1-C10 alkyl group unsubstituted or substituted with a halogen,
wherein the aromatic cyclic group is a single aromatic ring, a fused ring of two or more aromatic rings, or a linked ring moiety in which two or more aromatic rings are linked via a single bond, —O—, —S—, —C(═O)—, —S(═O)₂—, —Si(Ra)(Rb)- (wherein Ra and Rb are each independently a C1-C10 alkyl group), a C1-C10 alkylene group unsubstituted or substituted with a halogen, or —C(═O)—NH—O,
Ar₃ and Ar₆ are each independently an aromatic cyclic group selected from among: a divalent C6-C24 arylene group unsubstituted or substituted with fluorine or a C1-C10 alkyl group unsubstituted or substituted with fluorine; and a divalent C4-C24 heteroarylene group unsubstituted or substituted with fluorine or a C1-C10 alkyl group unsubstituted or substituted with fluorine,
wherein the aromatic cyclic group is a single aromatic ring, a fused ring of two or more aromatic rings, or a linked ring moiety of two or more aromatic rings linked via a single bond, —O—, —S—, —C(═O)—, —S(═O)₂—, —Si(Ra)(Rb)- (wherein Ra and Rb are each independently a C1-C10 alkyl group), a C1-C10 alkylene group unsubstituted or substituted with a halogen, or —C(═O)—NH—,
X₁ is —COOH, —OH, —CO—NH₂, or —COH,
Y₁ and Y₂ are each independently a single bond or a C1-C10 alkylene group substituted with fluorine; and
each of n and m is a mole fraction in a repeating unit satisfying 0<n<1, 0<m<1, and n+m=1.

6. The binder as claimed in claim 1, wherein the polyimide is represented by Formula 3 or formula 4: 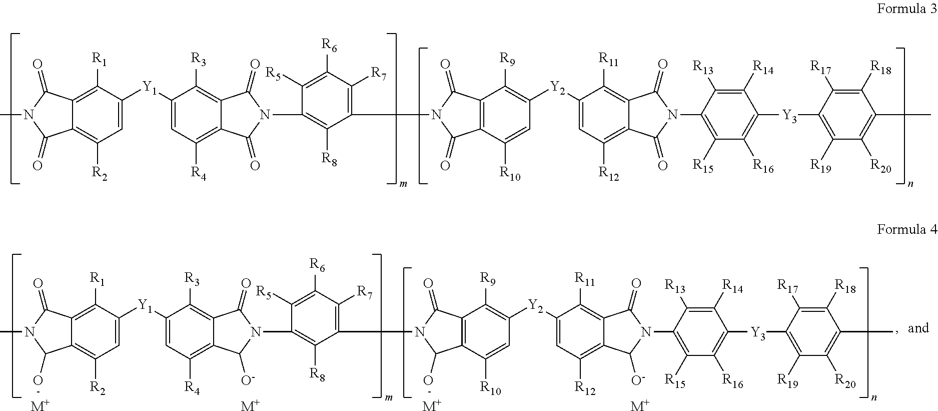
wherein in Formulae 3 and 4,
M is lithium or sodium,
R₁ to R₂₀ are each independently: hydrogen, a halogen; —COOH; —OH; —CO—NH₂; —COH; a C1-C10 alkyl group unsubstituted or substituted with a halogen; a C6-C20 aryl group unsubstituted or substituted with a halogen; or a C2-C20 heteroaryl group unsubstituted or substituted with a halogen,
wherein at least one selected from among R₅ to R₈ is —COOH, —OH, —CO—NH₂, or —COH,
at least one selected from among R₁₃ to R₂₀ is a C1-C10 alkyl group substituted with fluorine,
Y₁ to Y₃ are each independently a single bond or a C1-C10 alkylene group substituted with fluorine; and
each of n and m is a mole fraction in a repeating unit satisfying 0<n<1, 0<m<1, and n+m=1.

7. The binder as claimed in claim 1, wherein the polyamic acid is represented by Formula 7 or Formula 8: 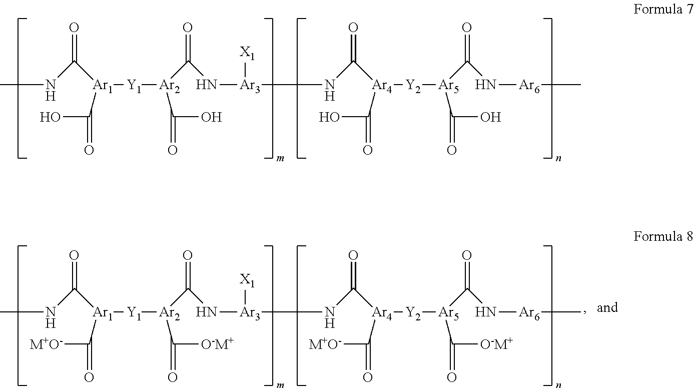
wherein in Formulae 7 and 8,
M is an alkali metal,
Ar₁, Ar₂, Ar₄, and Ar₅ are each independently an aromatic cyclic group selected from among: a trivalent C6-C24 arylene group unsubstituted or substituted with a halogen or a C1-C10 alkyl group unsubstituted or substituted with a halogen; and a trivalent C4-C24 heteroarylene group unsubstituted or substituted with a halogen or a C1-C10 alkyl group unsubstituted or substituted with a halogen,
wherein the aromatic cyclic group is a single aromatic ring, a fused ring of two or more aromatic rings, or a linked ring moiety of two or more aromatic rings linked via a single bond, —O—, —S—, —C(═O)—, —S(═O)₂—, —Si(Ra)(Rb)- (wherein Ra and Rb are each independently a C1-C10 alkyl group), a C1-C10 alkylene group unsubstituted or substituted with a halogen, or —C(═O)—NH—O,
Ar₃ and Ar₆ are each independently an aromatic cyclic group selected from among: a divalent C6-C24 arylene group unsubstituted or substituted with fluorine or a C1-C10 alkyl group unsubstituted or substituted with fluorine; and a divalent C4-C24 heteroarylene group unsubstituted or substituted with fluorine or a C1-C10 alkyl group unsubstituted or substituted with fluorine,
wherein the aromatic cyclic group is a single aromatic ring, a fused ring of two or more aromatic rings, or a linked ring moiety of two or more aromatic rings linked via a single bond, —O—, —S—, —C(═O)—, —S(═O)₂—, —Si(Ra)(Rb)- (wherein Ra and Rb are each independently a C1-C10 alkyl group), a C1-C10 alkylene group unsubstituted or substituted with a halogen, or —C(═O)—NH—,
X₁ is —COOH, —OH, —CO—NH₂, or —COH,
Y₁ and Y₂ are each independent a single bond or a C1-C10 alkylene group substituted with fluorine; and
each of n and m is a mole fraction in a repeating unit satisfying 0<n<1, 0<m<1, and n+m=1.

8. The binder as claimed in claim 1, wherein the polyamic acid is represented by Formula 9 or Formula 10: 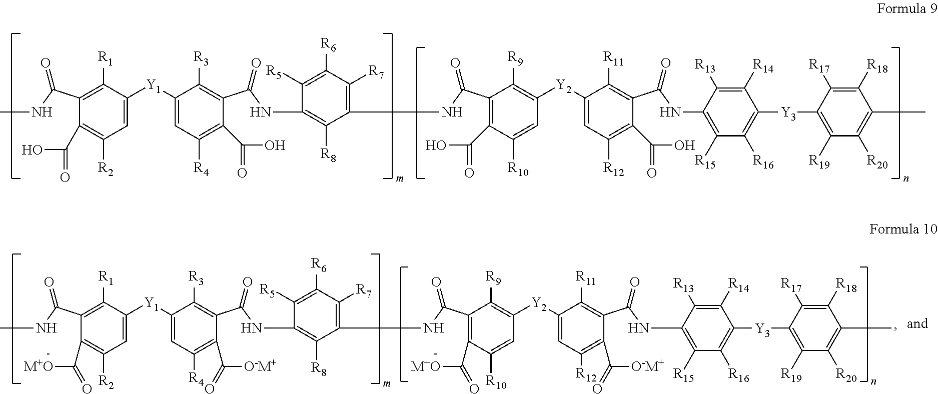
wherein in Formulae 9 and 10,
M is lithium or sodium,
R₁ to R₂₀ are each independently hydrogen; a halogen; —COOH; —OH; —CO—NH₂; —COH; a C1-C10 alkyl group unsubstituted or substituted with a halogen; a C6-C20 aryl group unsubstituted or substituted with a halogen; or a C2-C20 heteroaryl group unsubstituted or substituted with a halogen,
at least one selected from among R₅ to R₈ is —COOH, —OH, —CO—NH₂, or —COH,
at least one selected from among R₁₃ to R₂₀ is a C1-C10 alkyl group substituted with fluorine,
Y₁ to Y₃ are each independently a single bond or a C1-C10 alkylene group substituted with fluorine; and
each of n and m is a mole fraction in a repeating unit satisfying 0<n<1, 0<m<1, and n+m=1.

9. The binder as claimed in claim 1, wherein the polyimide is represented by Formula 5 or Formula 6, and the polyamic acid is represented by Formula 11 or Formula 12: 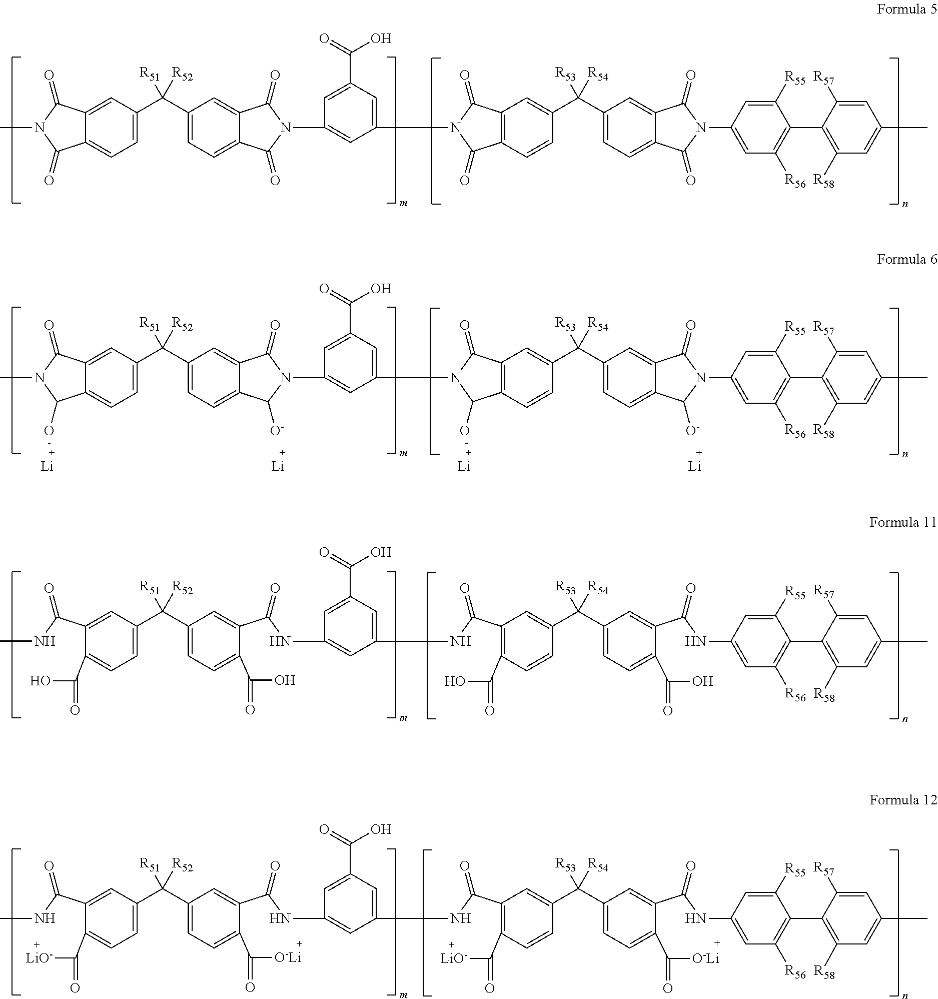
wherein in Formulae 5, 6, 11, and 12,
R₅₁ to R₅₈ are each independently hydrogen or a C1-C10 alkyl group unsubstituted or substituted with fluorine,
at least one selected from among R₅₁ to R₅₈ is a C1-C10 alkyl group substituted with fluorine, and
each of n and m is a mole fraction in a repeating unit satisfying 0<n<1, 0<m<1, and n+m=1.

10. The binder as claimed in claim 9, wherein 0<m<0.5, 0.5<n<1, and n+m=1 are satisfied.

11. The binder as claimed in claim 1, wherein the water-soluble second polymer is a polymerization product of at least one monomer selected from among vinyl monomers, acetate monomers, alcohol monomers, acrylic monomers, methacrylic monomers, acrylamide monomers, and methacrylamide monomers, and/or a hydrolysate thereof.

12. The binder as claimed in claim 1, wherein the water-soluble second polymer is a polymerization product of at least one monomer selected from among vinyl acetate, vinyl alcohol, butyl (meth)acrylate, 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 2-hydroxyethyleneglycol (meth)acrylate, 2-hydroxypropyleneglycol (meth)acrylate, acrylic acid, methacrylic acid, 2-(meth)acryloyloxy acetic acid, 3-(meth)acryloyloxy propyl acid, 4-(meth)acryloyloxy butyl acid, itaconic acid, maleic acid, 2-isocyanatoethyl (meth)acrylate, 3-isocyanatopropyl (meth)acrylate, 4-isocyanatobutyl (meth)acrylate, (meth)acrylamide, ethylenedi(meth)acrylate, diethyleneglycol(meth)acrylate, triethyleneglycoldi(meth)acrylate, trimethylenepropanetri(meth)acrylate, trimethylenepropanetriacrylate, 1,3-butanediol(meth)acrylate, 1,6-hexanedioldi(meth)acrylate, allylacrylate, and N-vinyl caprolactam, and/or a hydrolysate thereof.

13. The binder as claimed in claim 1, wherein the water-soluble second polymer is polyvinylalcohol.

14. The binder as claimed in claim 1, wherein a weight ratio of the first polymer to the water-soluble second polymer is about 1:99 to about 50:50.

15. The binder as claimed in claim 1, wherein the third polymer is represented by one selected from among Formulae 13 to 16: 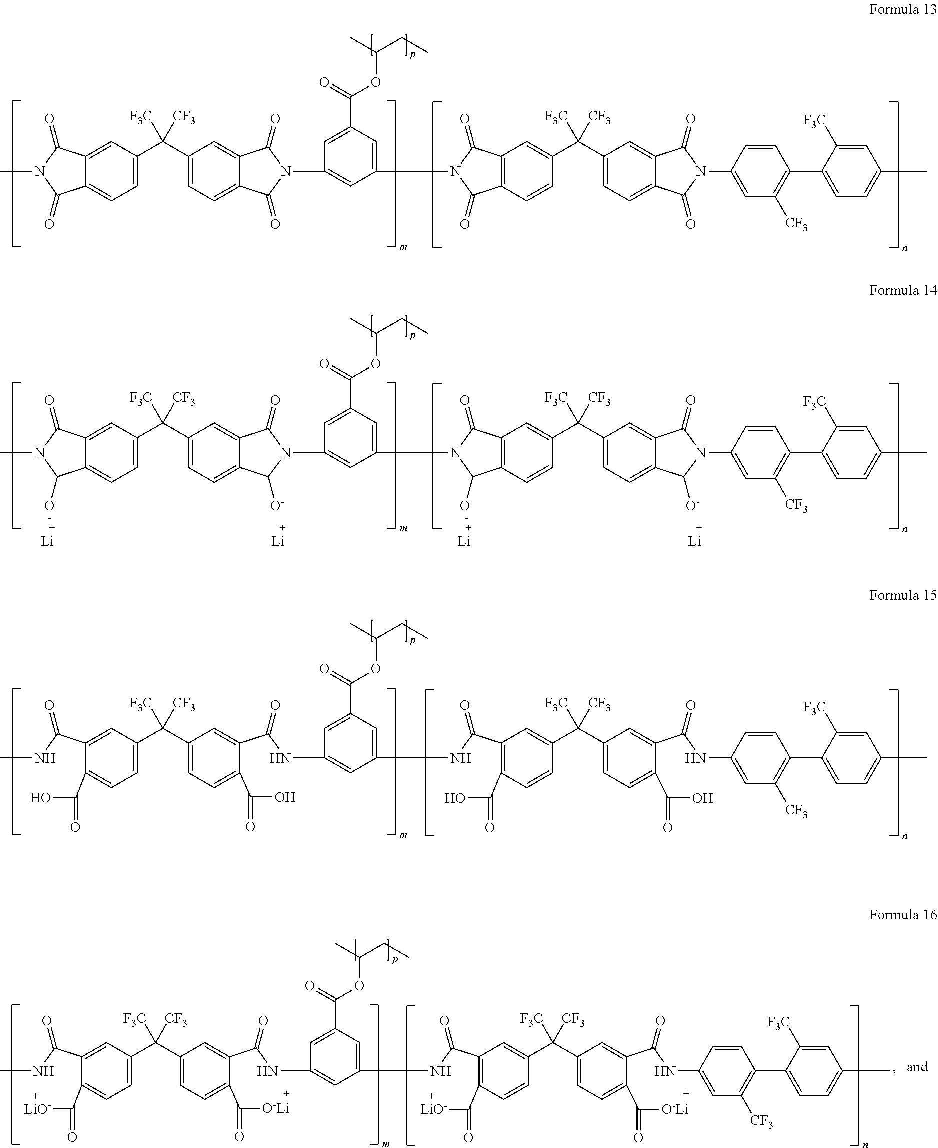
wherein in Formulae 13 to 16, each of n and m is a mole fraction in a repeating unit satisfying 0<n<1, 0<m<1, and n+m=1, and p, as a degree of polymerization, is about 250 to about 12500.

16. An anode comprising:
an anode current collector; and
a protective layer on the anode current collector and comprising the binder as claimed in claim 1.

17. The anode as claimed in claim 16, wherein the protective layer has a thickness of 5 μm or less.

18. The anode as claimed in claim 16, wherein the anode current collector comprises a base film and a metal layer on at least one side of the base film, and
wherein the base film comprises a polymer, the polymer comprising polyethyleneterephthalate, polyethylene, polypropylene, polybutyleneterephthalate, polyimide, or any combination thereof, and
the metal layer comprises indium, copper, magnesium, stainless steel, titanium, iron, cobalt, nickel, zinc, aluminum, germanium, lithium, or any alloy thereof.

19. A lithium battery comprising:
a cathode;
the anode as claimed in claim 16; and
an electrolyte between the cathode and the anode.

20. The lithium battery as claimed in claim 19, wherein the electrolyte is a liquid electrolyte, a solid electrolyte, or any combination thereof.
